(19) United States
(12) Patent Application Publication
(10) Pub. No.: US 2026/0225122 A1
(43) Pub. Date: Aug. 6, 2026

(54) TUBE INNER WALL COATING APPARATUS

(71) Applicant: EWHA UNIVERSITY-INDUSTRY COLLABORATION FOUNDATION, SEOUL (KR)

(72) Inventors: CHANHYUK PARK, SEOUL (KR); SOYOUN KIM, GYEONGGI-DO (KR); HYEYOOL KIM, SEOUL (KR)

(21) Appl. No.: 19/437,432

(22) Filed: Dec. 31, 2025

(30) Foreign Application Priority Data
Jan. 31, 2025 (KR) 1020250012523
Jan. 31, 2025 (KR) 1020250012524
Jun. 30, 2025 (KR) 1020250086939
Jun. 30, 2025 (KR) 1020250086940

(51) Int. Cl. B05B 13/06; B05B 13/04; B05C 9/12

(52) U.S. Cl. CPC B05B 13/06; B05B 13/0421; B05C 9/12

(57) ABSTRACT

A tube inner wall coating apparatus may include a base part having an upper plate, a tube mounting part on which the tube is mounted, a coating liquid spray part configured to be inserted into the tube and form a coating layer on an inner wall of the tube by spraying a coating liquid toward the inner wall of the tube, a viscosity detection part configured to detect viscosity of the coating liquid before the coating liquid spray part sprays the coating liquid, a camera configured to acquire an image of the inner wall of the tube and an image of an outer surface of the tube, and an air spray part configured to cure the coating layer by spraying compressed air toward the inner wall of the tube formed with the coating layer.

### CROSS-REFERENCE TO RELATED APPLICATIONS

This application claims the priority of Korean Patent Application Nos. 10-2025-0012523 and 10-2025-0012524, both filed on Jan. 31, 2025, and 10-2025-0086939 and 10-2025-0086940, both filed on Jun. 30, 2025, in the Korean Intellectual Property Office, the disclosures of which are incorporated herein by reference.

### BACKGROUND

### Field

The present disclosure relates to a tube inner wall coating apparatus, and more particularly, to a tube inner wall coating apparatus capable of uniformly spraying a coating liquid and compressed air onto an inner wall of a tube formed with a hollow portion or capable of generating pressure to allow a coating liquid to flow and then curing a coating layer by spraying compressed air.

### Description of the Related Art

Recently, the use of tubes with hollow portions has been diversified. In a medical field or a field requiring cleanliness, the inside of the tube formed with the hollow portion needs to be coated to allow contents to move hygienically. However, in case that an inner wall of the tube formed with the hollow portion is coated, it is very difficult to coat the inner wall of the tube with a uniform coating thickness.

In the related art, the coating is performed by spraying flux onto the tube. However, in this case, there is a problem in that the amount of use of flux increases, and it is difficult to adjust a thickness of a coating film.

In addition, a hollow fiber membrane module is a filtration device that uses hollow fibers as a separator. The hollow fiber membrane module is used in various fields including a water treatment field or a medical field such as blood processing. Because the hollow fibers have fine hollow portions, the hollow fibers are coated by injecting a coating liquid into the fine hollow portions.

However, in case that the coating liquid is injected into the fine hollow portions as described above, the coating liquid is not uniformly applied onto inner walls of the fine hollow portion, which causes a problem in that efficiency of a hollow fiber membrane is not ensured.

### SUMMARY

Accordingly, the present disclosure has been made in an effort to solve the above-mentioned problem, and an object of the present disclosure is to provide a tube inner wall coating apparatus capable of precisely spraying a coating liquid onto an inner wall of a tube formed with a hollow portion, and allowing the coating liquid to uniformly spread along the inner wall of the tube, thereby coating the inner wall of the tube with a uniform thickness.

In addition, another object of the present disclosure is to provide a tube inner wall coating apparatus capable of spraying a coating liquid onto an inner wall of a tube formed with a hollow portion, and then applying pressure to allow the coating liquid to flow along the inner wall of the tube, thereby coating the inner wall of the tube with a uniform thickness.

Further, another object of the present disclosure is to provide a tube inner wall coating apparatus capable of coating an inner wall of a tube, which is formed with a hollow portion, with a coating liquid with a uniform thickness, and then curing the coating liquid, which is applied onto the inner wall of the tube, with a uniform thickness by spraying compressed air onto the inner wall of the tube.

However, technical problems to be solved by the present disclosure are not limited to the above-mentioned technical problems, and other technical problems, which are not mentioned above, may be clearly understood from the following descriptions by those skilled in the art to which the present disclosure pertains.

In order to achieve the above-mentioned objects, a tube inner wall coating apparatus according to one embodiment of the present disclosure may include a base part having an upper plate, a tube mounting part on which the tube is mounted so that a position of the tube formed with a hollow portion is fixed to an upper portion of the base part, a coating liquid spray part configured to be inserted into the tube and form a coating layer on an inner wall of the tube by spraying a coating liquid toward the inner wall of the tube, a viscosity detection part configured to detect viscosity of the coating liquid before the coating liquid spray part sprays the coating liquid, a camera configured to acquire an image of the inner wall of the tube and an image of an outer surface of the tube, an air spray part configured to cure the coating layer by spraying compressed air toward the inner wall of the tube formed with the coating layer, and a controller configured to control the coating liquid spray part so that the coating liquid is sprayed in a normal spray rate range of the coating liquid matched with the viscosity of the coating liquid and a diameter of the hollow portion calculated by analyzing at least one of the image of the inner wall of the tube and the image of the outer surface of the tube, and control the air spray part so that the compressed air is sprayed toward the inner wall of the tube when a predetermined time elapses after the coating liquid spray part sprays the coating liquid.

In order to achieve the above-mentioned objects, a tube inner wall coating apparatus according to another embodiment of the present disclosure may include a base part having an upper plate, a pressure adjustment part including a fixing part configured to fix a position of a tube formed with a hollow portion to an upper portion of the base part, and a pressure generation part configured to apply pressure into the tube while a coating liquid is sprayed toward an inner wall of the tube, a coating liquid spray part configured to be inserted into the tube and form a coating layer on the inner wall of the tube by means of a spray nozzle configured to spray the coating liquid, a viscosity detection part configured to detect viscosity of the coating liquid before the coating liquid spray part sprays the coating liquid, a camera configured to acquire an image of the inner wall of the tube and an image of an outer surface of the tube, an air spray part configured to cure the coating layer by spraying compressed air toward the inner wall of the tube formed with the coating layer, and a controller configured to control the coating liquid spray part so that the coating liquid is sprayed in a normal spray rate range of the coating liquid matched with the viscosity of the coating liquid and a diameter of the hollow portion calculated by analyzing at least one of the image of the inner wall of the tube and the image of the outer surface of the tube, and control the air spray part so that the compressed air is sprayed toward the inner wall of the tube when a predetermined time elapses after the coating liquid spray part sprays the coating liquid.

According to the present disclosure, it is possible to precisely spray the coating liquid onto the inner wall of the tube formed with the hollow portion, and allow the coating liquid to uniformly spread along the inner wall of the tube, thereby coating the inner wall of the tube with a uniform thickness.

In addition, according to the present disclosure, it is possible to spray the coating liquid onto the inner wall of the tube formed with the hollow portion and then apply pressure to allow the coating liquid to flow along the inner wall of the tube, thereby coating the inner wall of the tube with a uniform thickness.

Further, according to the present disclosure, it is possible to coat the inner wall of the tube formed with the hollow portion with the coating liquid with a uniform thickness and then spray compressed air onto the inner wall of the tube, thereby maximally quickly and accurately curing the coating liquid, which is applied onto the inner wall of the tube, with a uniform thickness.

Meanwhile, the effects obtained by the present disclosure are not limited to the aforementioned effects, and other effects, which are not mentioned above, will be clearly understood by those skilled in the art from the following description.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an exemplified view of a tube inner wall coating apparatus according to an embodiment of the present disclosure.

FIG. 2 is an exemplified view of a coating liquid spray part according to the embodiment of the present disclosure.

FIG. 3 is a view for explaining a method of sliding and rotating a spray nozzle according to the embodiment of the present disclosure.

FIG. 4 is an exemplified view of an air spray part according to the embodiment of the present disclosure.

FIG. 5 is a control block diagram of a controller according to the embodiment of the present disclosure.

FIG. 6 is a flowchart of a tube inner wall coating method according to a first-first embodiment of the present disclosure.

FIG. 7 is a flowchart of a tube inner wall coating method according to a first-second embodiment of the present disclosure.

FIG. 8 is a flowchart of a tube inner wall coating method according to a first-third embodiment of the present disclosure.

FIG. 9 is a flowchart of a tube inner wall coating method according to a first-fourth embodiment of the present disclosure.

FIG. 10 is a flowchart of a tube inner wall coating method according to a first-fifth embodiment of the present disclosure.

FIG. 11 is an exemplified view of a tube inner wall coating apparatus according to another embodiment of the present disclosure.

FIG. 12 is an exemplified view of a coating liquid spray part according to another embodiment of the present disclosure.

FIG. 13 is an exemplified view of an air spray part according to another embodiment of the present disclosure.

FIG. 14 is a control block diagram of a controller according to another embodiment of the present disclosure.

FIG. 15 is a flowchart of a tube inner wall coating method according to a second-first embodiment of the present disclosure.

FIG. 16 is a flowchart of a tube inner wall coating method according to a second-second embodiment of the present disclosure.

FIG. 17 is a flowchart of a tube inner wall coating method according to a second-third embodiment of the present disclosure.

FIG. 18 is a flowchart of a tube inner wall coating method according to a second-fourth embodiment of the present disclosure.

FIG. 19 is a flowchart of a tube inner wall coating method according to a second-fifth embodiment of the present disclosure.

### DETAILED DESCRIPTION

### Tube Inner Wall Coating Apparatus and Operation of First Embodiment

### 1) Configuration of Tube Inner Wall Coating Apparatus of First Embodiment

Hereinafter, a tube inner wall coating apparatus 1 according to an embodiment of the present disclosure will be described in detail with reference to the accompanying drawings.

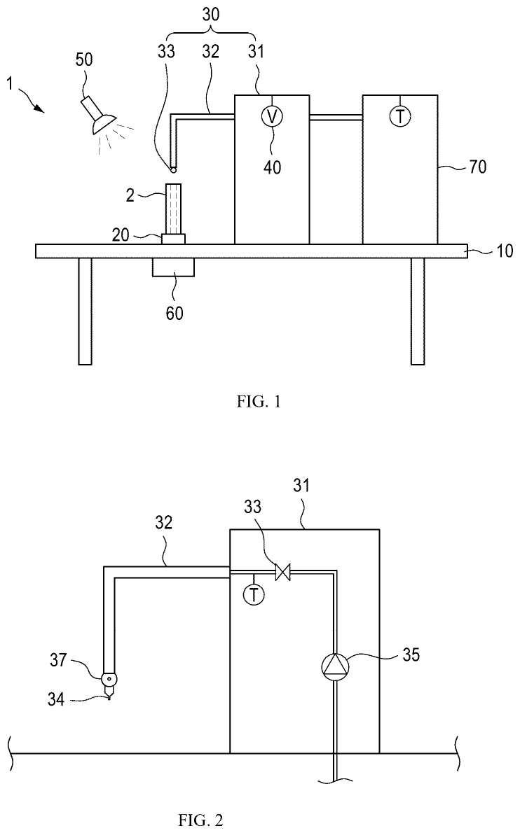

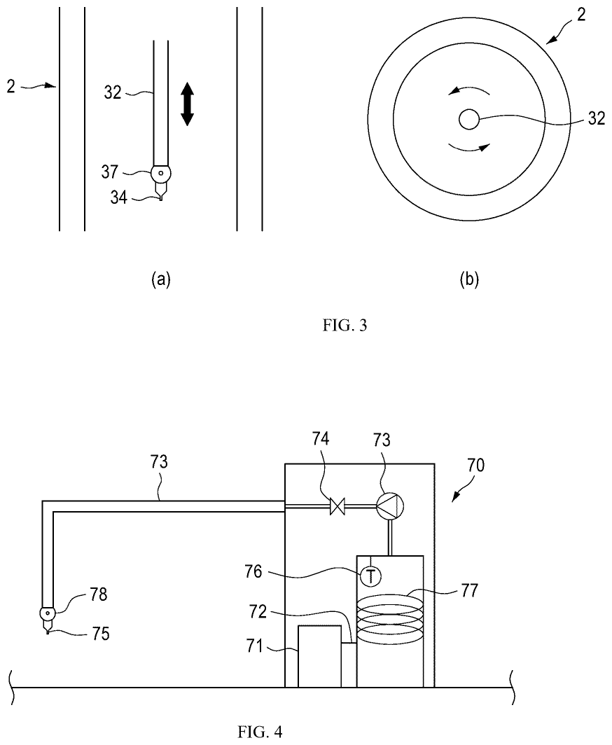

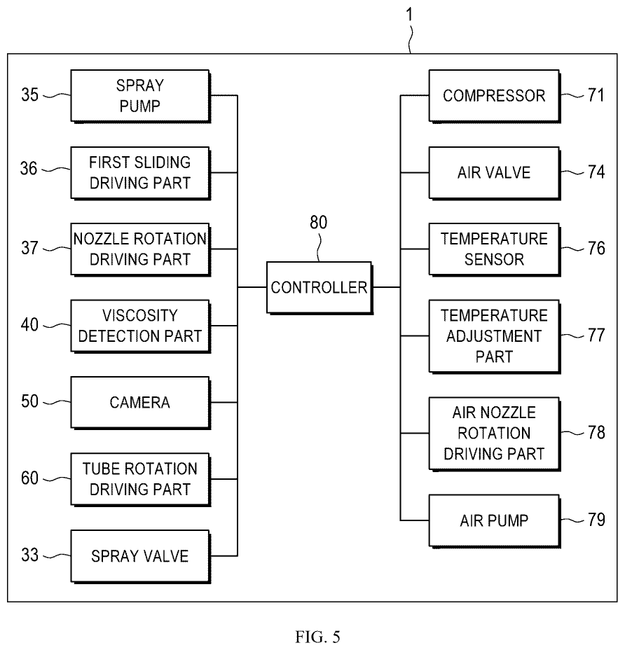

FIG. 1 is an exemplified view of a tube inner wall coating apparatus according to an embodiment of the present disclosure, FIG. 2 is an exemplified view of a coating liquid spray part according to the embodiment of the present disclosure, FIG. 3 is a view for explaining a method of sliding and rotating a spray nozzle according to the embodiment of the present disclosure, FIG. 4 is an exemplified view of an air spray part according to the embodiment of the present disclosure, and FIG. 5 is a control block diagram of a controller according to the embodiment of the present disclosure.

With reference to FIG. 1, the tube inner wall coating apparatus 1 according to the embodiment of the present disclosure is an apparatus that uniformly sprays a coating liquid and compressed air onto an inner wall of a tube 2 formed with a hollow portion, and the tube inner wall coating apparatus 1 includes a base part 10, a tube mounting part 20, a coating liquid spray part 30, a viscosity detection part 40, a camera 50, a tube rotation driving part 60, an air spray part 70, a controller 80, and a storage part (not illustrated).

In the embodiment, the base part 10 may be configured to support the tube mounting part 20, the coating liquid spray part 30, the viscosity detection part 40, the camera 50, the tube rotation driving part 60, the air spray part 70, and the controller 80 and have legs and an upper plate on which processes are performed.

In the embodiment, the tube mounting part 20 may be disposed on an upper portion of the base part 10, and the tube 2 formed with the hollow portion may be mounted on the tube mounting part 20 so that a position of the tube 2 formed with the hollow portion is fixed while the coating liquid and the compressed air are sprayed onto the inner wall of the tube 2 formed with the hollow portion.

In the embodiment, the tube 2 may be a cylindrical hollow fiber membrane formed with the hollow portion and having a circular cross-section. The tube mounting part 20 is maintained in a state in which the tube mounting part 20 is larger in diameter than the tube 2 to mount the tube 2. When the tube 2 needs to be fixed, the tube mounting part 20 may be adjusted to suit the diameter of the tube 2, such that the tube mounting part 20 may fix the position of the tube 2 in a shape in which the tube mounting part 20 holds a distal end region of the tube 2.

The tube mounting part 20 may fix the tube 2 by being manipulated by a user of the tube inner wall coating apparatus 1 for coating the tube formed with the hollow portion. In accordance with design, the tube mounting part 20 may fix the tube 2 while the operation of the tube mounting part 20 is remotely controlled by the controller 80.

In addition, a coating process of spraying the coating liquid onto the inner wall of the tube 2 and a curing process of curing a coating layer formed on the inner wall of the tube 2 are completed, the tube mounting part 20 may unfix the tube 2, on which the coating and curing processes are completed, in order to coat and cure another tube 2 on which the coating and curing processes are to be performed.

Additionally, the embodiment has been described in which the tube mounting part 20 is disposed on the upper portion of the base part 10. However, this configuration may be understood as a configuration in which the tube mounting part 20 is rotatably coupled to the upper portion of the base part 10 by means of the tube rotation driving part 60 so that the inner wall of the tube 2 is uniformly coated and the coating layer is uniformly cured even in case that a spray nozzle 34 and an air nozzle 75, which are configured to rotate, are not rotated in accordance with the design and modification.

In the embodiment, the coating liquid spray part 30 may be supported on the base part 10 and spray the coating liquid onto the inner wall of the tube 2 mounted on the tube mounting part 20.

With reference to FIGS. 2 and 5, in order to spray the coating liquid onto the inner wall of the tube 2 formed with the hollow portion, the coating liquid spray part 30 includes a spray main body 31, a spray pipe 32, a spray valve 33, the spray nozzle 34, a spray pump 35, a first sliding driving part 36, and a nozzle rotation driving part 37.

In the embodiment, the spray main body 31 is formed with an accommodation space for accommodating therein the spray valve 33 and the spray pump 35. In some instances, the spray main body 31 may be separated from the base part 10 to perform maintenance of the inside of the spray main body 31.

In the embodiment, the spray pipe 32 may have a distal end region coupled to the spray main body 31 so that the spray pipe 32 is slidable in an upward or downward direction. A conduit may be formed in the spray pipe 32 to provide a movement route for moving the coating liquid to the spray nozzle 34.

In addition, a rotary shaft may be provided in the distal end region of the spray pipe 32 to which the spray nozzle 34 is coupled, and the rotary shaft may serve to rotate the spray nozzle 34. The conduit of the spray pipe 32 may extend and be formed in the rotary shaft to supply the coating liquid to the spray nozzle 34. The conduit may be connected to a pressure adjustment system, which is controlled by the controller 80, and supply the coating liquid into the spray nozzle 34 at a predetermined rate. A sealing device may be included to prevent the coating liquid from leaking to the outside during the process of supplying the coating liquid to the spray nozzle 34, thereby maintaining a sealed state in order to prevent the coating liquid from leaking even while the rotary shaft rotates.

The spray pipe 32 may have a long cylindrical rail structure so that even a plurality of spray nozzles 34 may be mounted. That is, the spray nozzle 34 of the present disclosure may be provided as a plurality of spray pipes 32 that are mounted.

In the embodiment, the spray valve 33 may be disposed on the spray pipe 32. The movement route of the spray pipe 32 may be opened or closed to allow the coating liquid to move along the spray pipe 32 or block the movement of the coating liquid.

In addition, although not illustrated in the drawings, the spray valve 33 may be a small-scale cylindrical valve, and a precise spring may be embedded in the spray valve 33. A flow rate of the coating liquid may be adjusted by elastically adjusting the spring.

Further, the spray valve 33 may be equipped with a variable slit that may be adjusted at a level of several micrometers in order to maintain a predetermined flow of the coating liquid, thereby adjusting pressure of the coating liquid.

The spray valve 33 may be implemented as an electronic control-type valve. The spray valve 33 may be configured to open the movement route of the spray pipe 32 when the controller 80 controls the spray nozzle 34 so that the spray nozzle 34 sprays the coating liquid from the spray nozzle 34 within a normal spray rate range of the coating liquid, and the spray valve 33 may be configured to close the movement route of the spray pipe 32 before the controller 80 controls the spray nozzle 34.

In the embodiment, the spray nozzle 34 may be rotatably coupled to the distal end region of the spray pipe 32 that may be inserted into the tube 2 formed with the hollow portion, and the spray nozzle 34 may have one or more coating liquid discharge ports (not illustrated) configured to spray the coating liquid, which moves along the movement route formed in the spray pipe 32, toward the inner wall of the tube 2 formed with the hollow portion.

The spray nozzle 34 may form the coating layer with a predetermined pattern by coating the inner wall of the tube 2 in the form of a line by spraying the coating liquid in the form of a line (or string) along the inner wall of the tube 2 while the spray nozzle 34 slides in an upward/downward direction, as illustrated in FIG. 3A, and rotates while facing the inner wall of the tube 2, as illustrated in FIG. 3B, based on the sliding movement of the spray pipe 32 and the rotation made by the nozzle rotation driving part 37 in order to uniformly spray the coating liquid to the inner wall of the tube 2.

In addition, a spray hole of the spray nozzle 34 may be formed in the shape of a long hole.

Further, a nozzle tip of the spray nozzle 34 may be designed in the form of a cylindrical needle having a diameter of less than 0.1 mm, and the spray nozzle 34 may have one or more fine spray ports having a size of 20 to 50 mm.

In addition, the inside of the spray nozzle 34 may be smoothly coated to prevent residue of a coating solution from accumulating in the conduit configured to move the coating liquid. The spray nozzle 34 may be narrowed from one end, at which the coating liquid is received from the spray pipe 32, to the other end, at which the coating liquid is discharged, and the spray nozzle 34 may have a structure that is gradually narrowed. Therefore, the spray nozzle 34 may accelerate the flow of the coating liquid, thereby spraying the coating liquid in the form of fine fog (or mist).

Further, the spray nozzle 34 may be provided with a small rotary disc provided at the other end of the conduit, or a fine swirl pattern may be engraved at the other end of the conduit, thereby imparting a fine rotational force when the coating liquid is sprayed. Therefore, the spray nozzle 34 may enable the coating liquid to uniformly spread at a wide angle when the spray nozzle 34 sprays the coating liquid, and a small protruding portion is formed at an end of the spray nozzle 34, which communicates with the other end of the conduit, such that the coating liquid may be immediately sprayed without accumulating.

Additionally, the spray nozzle 34 may be made of stainless steel or ceramic material, thereby ensuring durability and maintaining precise spray performance.

In the embodiment, the spray pump 35 may be disposed on the spray pipe 32 and apply pressure to the coating liquid so that the coating liquid moves along the movement route formed in the spray pipe 32.

Although not illustrated in the drawings, the spray pump 35 may have a compact rectangular parallelepiped shape and have a structure in which a piston moves rectilinearly. In this case, the piston may precisely push the coating liquid while applying pressure to the coating liquid, thereby maintaining constant pressure for moving the coating liquid.

Furthermore, the spray pump 35 may be coated with a corrosion-resistant coating, thereby preventing damage (or corrosion) caused by chemical properties of the coating liquid.

In the embodiment, in order to coat the inner wall of the tube 2 formed with the hollow portion, the first sliding driving part 36 may slide the distal end region of the spray pipe 32 so that the distal end region of the spray pipe 32 departs from the inside of the tube 2 to the outside when a process of inserting the distal end region of the spray pipe 32 into the tube 2 or a process of coating the inner wall of the tube 2 ends.

In this case, the distal end region of the spray pipe 32 refers to an end of the spray pipe 32 including the spray nozzle 34 and the nozzle rotation driving part 37. The distal end region of the spray pipe 32 may be slid upward or downward from the inside of the tube 2 by the first sliding driving part 36 during the coating process of coating the inner wall of the tube 2.

In the embodiment, the nozzle rotation driving part 37 may perform the rotational operation so that the spray nozzle 34 rotates about the end of the spray pipe 32.

In addition, the nozzle rotation driving part 37 may be a servo motor configured to rotate the spray nozzle 34. As illustrated in FIG. 3B, the nozzle rotation driving part 37 may rotate the spray nozzle 34 by 0 to 360° based on a horizontal direction in which the spray nozzle 34 faces the inner wall of the tube 2 so that the spray nozzle 34 may coat the inner wall of the tube 2. A lever-type clamp including a rubber pad may be provided to allow the spray nozzle 34 to be fixed without slipping at an angle set by the controller 80.

Further, the nozzle rotation driving part 37 includes an electronic control device configured to adjust a rotational speed of the spray nozzle 34 and controls rotational acceleration and deceleration to optimize a centrifugal force, such that the coating liquid is uniformly distributed on the inner wall of the tube 2.

Furthermore, a rotational speed sensor may be embedded in the nozzle rotation driving part 37 and monitor the rotational speed of the spray nozzle 34 in real time, thereby maintaining a constant rotational speed of the spray nozzle 34 by means of feedback control. In this case, the rotational speed sensor may automatically perform necessary adjustment by measuring a rotation angle and a speed of the motor.

When the spray nozzle 34 completely coats the inner wall of the tube 2, the nozzle rotation driving part 37 may reduce the rotational speed of the spray nozzle 34 and stop the rotation of the spray nozzle 34.

In the embodiment, the viscosity detection part 40 may be connected to the coating liquid spray part 30 through the spray main body 31 and detect viscosity of the coating liquid, which moves along the spray pipe 32, before the coating liquid is sprayed from the spray nozzle 34.

In this case, the viscosity detection part 40 may be implemented as at least one of a rotary viscometer configured to calculate viscosity by measuring resistance torque applied to a rotating spindle in the coating liquid, a vibrational viscometer configured to calculate viscosity from a change in energy required for the coating liquid to maintain a predetermined frequency, a resonance-type viscosity sensor configured to detect viscosity based on a change in resonant frequency measured by using a piezoelectric element, a tubular viscometer configured to measure viscosity based on the time for which the coating liquid passes through an internal conduit (tube), or an ultrasonic-based viscometer configured to measure viscosity in a contactless manner by using a propagation speed or damping characteristics of ultrasonic waves transmitted to the coating liquid.

In the embodiment, the camera 50 may acquire images of the inner wall and outer surface of the tube 2 by capturing an image of the inner wall of the tube 2 formed with the hollow portion and an image of the outer surface of the tube 2 mounted on the tube mounting part 20 before the inner wall of the tube 2 is coated. The camera 50 may transmit the acquired image of the inner wall of the tube 2 and the acquired image of the outer surface of the tube 2 to the controller 80.

In addition, in order to acquire the image of the inner wall of the tube 2, the camera 50 may be inserted into the tube 2 through the hollow portion of the tube 2 and acquire the image of the inner wall of the tube 2 before the spray nozzle 34 is inserted into the tube 2.

Further, when the spray nozzle 34 departs from the inside of the tube 2 to the outside after the coating layer is formed on the inner wall of the tube 2, the camera 50 may be inserted into the tube 2 again and acquire an image of the inner wall of the tube 2 on which the coating layer is formed.

That is, in the present disclosure, the image of the inner wall of the tube 2 refers to an image acquired by capturing, in real time, an image of the inner wall of the tube 2 before the inner wall of the tube 2 is coated with the coating liquid and by capturing, in real time, an image of the inner wall of the tube 2 coated in the form of a line with the coating liquid.

The type of camera 50 is not limited as long as the camera 50 may capture an image of the inside of the tube 2. In order to capture an image of the inside of the narrow tube 2, the camera 50 may be implemented as at least one of a borescope integrally equipped with a small-scale lens and a light source (LED), a fiberscope using an optical fiber bundle, a miniature CMOS/CCD module including a small-scale CMOS or CCD sensor, or a 360-degree endoscopic camera.

In the embodiment, the tube rotation driving part 60 may be supported by the base part 10 and perform a rotational operation to rotate the tube mounting part 20 relative to the base part 10.

In the embodiment, the air spray part 70 is supported by the base part 10 and configured to cure the coating layer by spraying compressed air toward the inner wall of the tube 2 on which the coating layer is formed as the tube 2 is mounted on the tube mounting part 20 and then coated with the coating liquid. FIG. 4 illustrates constituent elements for implementing this configuration.

With reference to FIG. 4, the air spray part 70 includes a compressor 71, a compression storage tank 72, an air pipe 73, an air valve 74, a second sliding driving part (not illustrated), the air nozzle 75, a temperature sensor 76, a temperature adjustment part 77, an air nozzle rotation driving part 78, and an air pump 79.

In the embodiment, the compressor 71 may produce compressed air by compressing outside air.

In this case, the compressor 71 may be implemented as at least one of a reciprocating compressor configured to compress outside air by using a rectilinear reciprocating motion of a piston, a screw compressor configured to compress outside air by using two rotating screw rotors, a Roots-type compressor configured to compress outside air by using two rotating rotors, a scroll compressor configured to compress outside air by using two spiral scrolls, or a centrifugal compressor configured to compress outside air by using a rotating impeller.

In the embodiment, the compression storage tank 72 may be connected to the compressor 71 and store compressed air discharged from the compressor 71.

In the embodiment, the air pipe 73 may be connected to the compression storage tank 72, and a conduit may be formed in the air pipe 73 to provide a movement route for moving the compressed air to the air nozzle 75.

In addition, a rotary shaft may be provided in a distal end region of the air pipe 73 to which the air nozzle 75 is coupled, and the rotary shaft may serve to rotate the air nozzle 75. The conduit of the air pipe 73 may extend and be formed in the rotary shaft to supply the compressed air to the air nozzle 75. The conduit may be connected to the pressure adjustment system, which is controlled by the controller 80, and supply the compressed air into the air nozzle 75 at a predetermined rate. A sealing device may be included to prevent the compressed air from leaking to the outside during the process of supplying the compressed air to the air nozzle 75, thereby maintaining a sealed state in order to prevent the compressed air from leaking even while the rotary shaft rotates.

The air pipe 73 may have a long cylindrical rail structure so that even a plurality of air nozzles 75 may be mounted. That is, the air nozzle 75 of the present disclosure may be provided as a plurality of air pipes 73 that are mounted.

In the embodiment, the air valve 74 may be disposed on the air pipe 73. The movement route of the air pipe 73 may be opened or closed to allow the compressed air to move along the air pipe 73 or block the movement of the compressed air.

The air valve 74 may be implemented as an electronic control-type valve that opens the movement route of the air pipe 73, when a temperature of the compressed air detected by the temperature sensor 76 is included in a normal temperature range, and closes the movement route of the air pipe 73 when the temperature of the compressed air is not included in the normal temperature range.

In the embodiment, in order to cure the coating layer with a predetermined thickness on the inner wall of the tube 2 formed with the hollow portion, the second sliding driving part (not illustrated) may slide the distal end region of the air pipe 73 so that the distal end region of the air pipe 73 departs from the inside of the tube 2 to the outside when a process of inserting the distal end region of the air pipe 73 into the tube 2 or a process of curing the inner wall of the tube 2 ends.

In this case, the distal end region of the air pipe 73 refers to an end of the air pipe 73 including the air nozzle 75 and the air nozzle rotation driving part 78. The distal end region of the air pipe 73 may be slid upward or downward in the tube 2 by the second sliding driving part (not illustrated) during the curing process of curing the coating layer formed on the inner wall of the tube 2.

In the embodiment, the air nozzle 75 may be rotatably coupled to the distal end region of the air pipe 73 that may be inserted into the tube 2 formed with the hollow portion, and the air nozzle 75 may have one or more compressed air discharge ports (not illustrated) configured to spray the compressed air, which moves along the movement route formed in the air pipe 73, toward the inner wall of the tube 2 formed with the hollow portion.

Like the spray nozzle 34 illustrated in FIG. 3, the air nozzle 75 may slide in the upward or downward direction and rotate to face the inner wall of the tube 2 based on the sliding movement of the air pipe 73 and the rotation made by the air nozzle rotation driving part 78 in order to cure the coating layer with a predetermined thickness on the inner wall of the tube 2 formed with the hollow portion. The air nozzle 75 may spray the compressed air in the form of a line (or string) along the inner wall of the tube 2 while sliding and rotating.

In the embodiment, the compressed air sprayed from the air nozzle 75 may be cooled compressed air that may not only uniformly cure the coating layer formed on the inner wall of the tube 2, but also shorten a period of time for the curing process.

To this end, the compression storage tank 72 may be provided with a temperature adjustment means (not illustrated) that may not only store the compressed air, but also cool the compressed air. The temperature adjustment means may be operated by the controller 80 and cool the compressed air.

In addition, in order to move the cooled compressed air, the air pipe 73 may be made of a material (e.g., stainless steel, Teflon, etc.) that prevents an inner wall of the conduit, which constitutes the movement route, from being frozen by the cooled compressed air.

In the embodiment, the temperature sensor 76 may be disposed in the compression storage tank 72 and detect a temperature of the compressed air stored in the compression storage tank 72.

The temperature sensor 76 may detect the temperature of the compressed air based on at least one of a thermal resistance method of measuring a temperature by using a property that resistance varies depending on a change in temperature of metal, a thermocouple method of measuring a temperature by using a thermoelectromotive force generated by joining two different types of metal, a thermistor method of measuring a temperature based on resistance that varies depending on the temperature, or an infrared non-contact method of measuring a temperature based on infrared radiant energy emitted from a surface of compressed air.

In the embodiment, the temperature adjustment part 77 may be disposed in the compression storage tank 72 and adjust the temperature of the compressed air stored in the compression storage tank 72.

Although not illustrated in the drawings, the temperature adjustment part 77 may include an electric heater (not illustrated) configured to raise a temperature of the compression storage tank 72, a cooler (not illustrated) containing a coolant for cooling high-temperature compressed air with a temperature raised by the electric heater, and a heat exchanger (not illustrated) configured to cool the coolant of the cooler.

In the embodiment, the air nozzle rotation driving part 78 may perform a rotational operation so that the air nozzle 75 rotates about the end of the air pipe 73.

In addition, the air nozzle rotation driving part 78 may be a servo motor configured to rotate the air nozzle 75. In order for the air nozzle 75 to cure the coating layer formed on the inner wall of the tube 2, the air nozzle rotation driving part 78 may rotate the air nozzle 75 by 0 to 360° based on the horizontal direction in which the air nozzle 75 faces the inner wall of the tube 2. A lever-type clamp including a rubber pad may be provided to allow the air nozzle 75 to be fixed without slipping at an angle set by the controller 80.

Further, the air nozzle rotation driving part 78 includes an electronic control device configured to adjust a rotational speed of the air nozzle 75 and controls rotational acceleration and deceleration to optimize a centrifugal force, such that the compressed air uniformly cures the coating layer formed on the inner wall of the tube 2.

Furthermore, a rotational speed sensor may be embedded in the air nozzle rotation driving part 78 and monitor the rotational speed of the air nozzle 75 in real time, thereby maintaining a constant rotational speed of the air nozzle 75 by means of feedback control. In this case, the rotational speed sensor may automatically perform necessary adjustment by measuring a rotation angle and a speed of the motor.

When the air nozzle 75 completely cures the coating layer formed on the inner wall of the tube 2, the air nozzle rotation driving part 78 may reduce the rotational speed of the air nozzle 75 and stop the rotation of the air nozzle 75.

In the embodiment, the air pump 79 may be disposed on the air pipe 73 and apply pressure to the compressed air so that the compressed air moves along the movement route formed in the air pipe 73.

Although not illustrated in the drawings, the air pump 79 may have a compact rectangular parallelepiped shape and have a structure in which a piston moves rectilinearly. In this case, the piston may precisely push the compressed air while applying pressure to the compressed air, thereby maintaining constant pressure for moving the compressed air.

With reference to FIG. 5, in order to form the coating layer with a predetermined thickness on the inner wall of the tube 2 formed with the hollow portion, in case that the normal spray rate range (e.g., 0.3 to 1.0 mL/sec) of the coating liquid, which is matched with the viscosity of the coating liquid and the diameter (size) of the hollow portion, is pre-stored in the storage part (not illustrated) and the diameter of the hollow portion of the tube 2 is calculated by analyzing the image of the inner wall of the tube 2 acquired from the camera 50 while the viscosity detection part 40 detects the viscosity of the coating liquid, the controller 80 may control the spray nozzle 34 so that the coating liquid is sprayed from the spray nozzle 34 within the normal spray rate range of the coating liquid pre-stored in the storage part (not illustrated) matched with the viscosity of the coating liquid detected by the viscosity detection part 40 and the diameter of the hollow portion calculated based on the image of the inner wall of the tube 2.

In a specific example, in case that the diameter of the hollow portion of the tube 2 is 10 mm and the viscosity of the coating liquid is 100 cp, the controller 80 may control the spray nozzle 34 so that the spray nozzle 34 sprays the coating liquid at a spray rate of 0.6 mL/sec.

In addition, in order to form the coating layer with a predetermined thickness on the inner wall of the tube 2 formed with the hollow portion, in case that a sliding movement speed (e.g., 0.5 to 3.0 mm/sec) of the spray pipe 32 and a rotational speed (e.g., 15 to 60 rpm) of the spray nozzle 34, which are matched with the viscosity of the coating liquid and the diameter of the hollow portion, are pre-stored in the storage part (not illustrated) and the diameter of the hollow portion of the tube 2 is calculated by analyzing the image of the inner wall of the tube 2 acquired from the camera 50 while the viscosity detection part 40 detects the viscosity of the coating liquid, the controller 80 may control the first sliding driving part 36 and the nozzle rotation driving part 37 so that the spray pipe 32 slides and the spray nozzle 34 rotates at the sliding movement speed of the spray pipe 32 and the rotational speed of the spray nozzle 34 pre-stored in the storage part (not illustrated) and matched with the viscosity of the coating liquid detected by the viscosity detection part 40 and the diameter of the hollow portion calculated based on the image of the inner wall of the tube 2.

In this case, the sliding movement speed of the spray pipe 32 and the rotational speed of the spray nozzle 34 may be pre-stored in the storage part (not illustrated) so as to be matched at a high level within a numerical value range pre-stored in the storage part (not illustrated) as the detected viscosity of the coating liquid decreases and the calculated diameter of the hollow portion decreases.

In a specific example, in case that the viscosity of the coating liquid in the tube 2 is 50 cp, the controller 80 may control the first sliding driving part 36 and the nozzle rotation driving part 37 so that the spray pipe 32 slides at 3.0 mm/sec and the spray nozzle 34 rotates at 60 rpm.

In another specific example, in case that the viscosity of the coating liquid is 500 cp, the controller 80 may control the first sliding driving part 36 and the nozzle rotation driving part 37 so that the spray pipe 32 slides at 0.5 mm/sec and the spray nozzle 34 rotates at 15 rpm.

Further, in order to form the coating layer with a predetermined thickness on the inner wall of the tube 2 formed with the hollow portion, in case that a normal angle range (e.g., 0 to 360°) of the spray nozzle 34 and a normal spray pressure range (e.g., 0.5 to 2.0 bar) of the coating liquid, which are matched with the diameter of the hollow portion of the tube 2 and an axial length of the inner wall of the tube 2, are pre-stored in the storage part (not illustrated) and the diameter of the hollow portion of the tube 2 and the axial length of the inner wall of the tube 2 are calculated by analyzing the images of the inner wall and outer surface of the tube 2 acquired from the camera 50, the controller 80 may control the nozzle rotation driving part 37 and the spray pump 35 so that the coating liquid is sprayed from the spray nozzle 34 within the normal angle range of the spray nozzle 34 and the normal spray pressure range of the coating liquid pre-stored in the storage part (not illustrated) and matched with the diameter of the hollow portion of the tube 2 and the axial length of the inner wall of the tube 2 calculated based on the images of the inner wall and outer surface of the tube 2.

In a specific example, in case that the diameter of the hollow portion of the tube 2 is 10 mm and the axial length of the inner wall of the tube 2 is 300 mm, the controller 80 may control the nozzle rotation driving part 37 and the spray pump 35 so that the spray nozzle 34 rotates at 330 to 360° and the spray nozzle 34 sprays the coating liquid at 1.5 bar.

In addition, in order to form the coating layer with a predetermined thickness on the inner wall of the tube 2 formed with the hollow portion, in case that a normal rotational speed (e.g., 30 to 120 rpm) of the tube mounting part 20, which is matched with the normal spray rate range of the coating liquid, is pre-stored in the storage part (not illustrated), the controller 80 may control the tube rotation driving part 60 so that the tube mounting part 20 rotates at the normal rotational speed pre-stored in the storage part (not illustrated) and matched with the normal spray rate range of the coating liquid when the spray nozzle 34 is controlled to spray the coating liquid within the normal spray rate range of the coating liquid.

In a specific example, in case that the normal spray rate range of coating liquid is 0.6 mL/sec, the controller 80 may control the tube rotation driving part 60 so that the tube mounting part 20 rotates at 80 rpm.

Further, in order to form the coating layer with a predetermined thickness on the inner wall of the tube 2 formed with the hollow portion, the controller 80 may control the air nozzle 75 so that the compressed air is sprayed toward the inner wall of the tube 2 fixed to the tube mounting part 20 when a predetermined time elapses after the coating liquid is sprayed.

In addition, in order to cure the coating layer with a predetermined thickness on the inner wall of the tube 2 formed with the hollow portion, in case that a normal temperature range (e.g., 30 to 50° C.) of the compressed air in the compression storage tank 72 and a sliding movement speed (e.g., 1.0 to 3.0 mm/sec) of the air pipe 73 and a rotational speed (e.g., 30 to 70 rpm) of the air nozzle 75, which are matched with the normal temperature range of the compressed air, are pre-stored in the storage part (not illustrated) and the temperature detected by the temperature sensor 76 deviates from the normal temperature range, the controller 80 may control the temperature adjustment part 77 so that the temperature of the compressed air in the compression storage tank 72 is included in the normal temperature range pre-stored in the storage part (not illustrated), and the controller 80 may control the second sliding driving part (not illustrated) and the air nozzle rotation driving part 78 so that the air pipe 73 slides and the air nozzle 75 rotates at the sliding movement speed of the air pipe 73 and the rotational speed of the air nozzle 75 pre-stored in the storage part (not illustrated) and matched with the temperature of the compressed air in the normal temperature range detected by the temperature sensor 76.

In a specific example, the controller 80 may control the temperature adjustment part 77 so that the temperature of the compressed air in the compression storage tank 72, which is detected by the temperature sensor 76, is 40° C., and the controller 80 may control the second sliding driving part (not illustrated) and the air nozzle rotation driving part 78 so that the air pipe 73 slides at 1.5 mm/sec and the air nozzle 75 rotates at 40 rpm so as to be matched with the detected temperature of the compressed air.

The controller 80 may include an electronic control circuit configured to control the constituent elements based on information transferred from the constituent elements illustrated in FIG. 5.

Furthermore, the controller 80 may be connected to the storage part (not illustrated) to control the operations of the constituent elements illustrated in FIG. 5. Although not illustrated in the drawings, a small-scale LED display (not illustrated) may be mounted on an outer portion of the controller 80.

In this case, the small-scale LED display (not illustrated) of the controller 80 may output and display the normal spray rate range of the coating liquid, the sliding movement speed of the spray pipe 32, the rotational speed of the spray nozzle 34, the normal angle range of the spray nozzle 34, the normal spray pressure range of the coating liquid, the normal rotational speed of the tube mounting part 20, the normal temperature range of the compressed air, the sliding movement speed of the air pipe 73, and the rotational speed of the air nozzle 75 that are pre-stored in the storage part (not illustrated). The entity, which pre-stores the pieces of information in the storage part (not illustrated), may be a user of the tube inner wall coating apparatus 1 for coating the tube formed with the hollow portion or a manager who supervises the operations of coating and curing the tube 2 formed with the hollow portion.

### 2) Operation of Tube Inner Wall Coating Apparatus of First Embodiment

Hereinafter, a tube inner wall coating method of coating the tube formed with the hollow portion according to the embodiment of the present disclosure performed by the tube inner wall coating apparatus 1 of the above-mentioned embodiment will be described in detail with reference to the accompanying drawings.

### First-First Embodiment

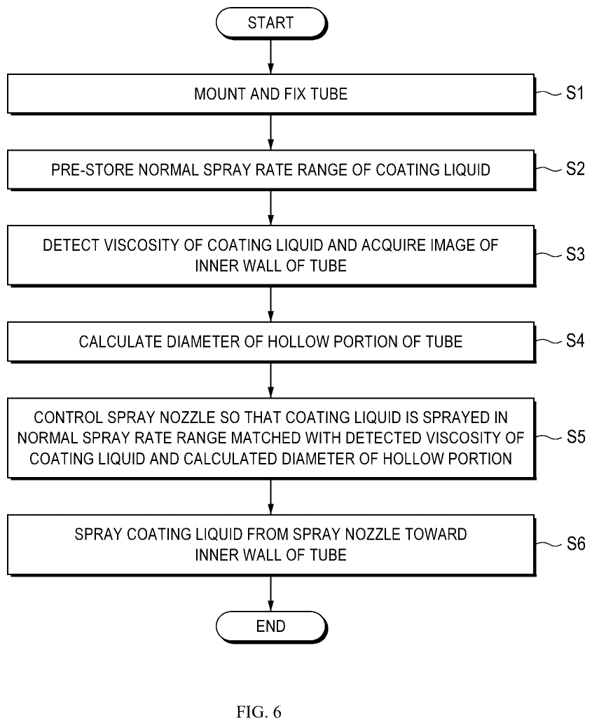

FIG. 6 is a flowchart of a tube inner wall coating method according to a first-first embodiment of the present disclosure.

With reference to FIG. 6, first, the user may mount the tube 2 on the tube mounting part 20 and fix the tube 2 (S1).

Thereafter, the user may pre-store the normal spray rate range of the coating liquid, which is matched with the viscosity of the coating liquid and the diameter (size) of the hollow portion of the tube 2, in the storage part (S2).

Thereafter, the viscosity detection part 40 may detect the viscosity of the coating liquid, and thereafter or at the same time, the camera 50 may be inserted into the tube 2 and then acquire the image of the inner wall of the tube 2 (S3).

Thereafter, the controller 80 may calculate the diameter of the hollow portion of the tube 2 by analyzing the image of the inner wall of the tube 2 acquired from the camera 50 (S4).

Thereafter, in order to form the coating layer with a predetermined thickness on the inner wall of the tube 2 formed with the hollow portion, the controller 80 may control the spray nozzle 34 so that the spray nozzle 34 sprays the coating liquid within the normal spray rate range of the coating liquid pre-stored in the storage part (not illustrated) and matched with the viscosity of the coating liquid detected by the viscosity detection part 40 and the diameter of the hollow portion calculated based on the image of the inner wall of the tube 2 (S5).

Thereafter, the spray nozzle 34 may be inserted into the tube 2 and then spray the coating liquid toward the inner wall of the tube 2 within the normal spray rate range pre-stored in the storage part (not illustrated) by the controller 80 (S6).

### First-Second Embodiment

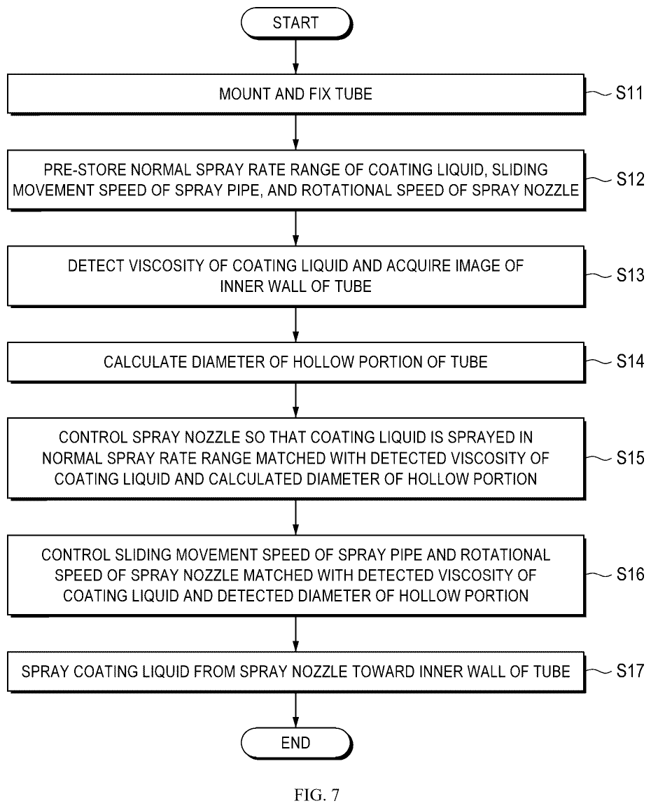

FIG. 7 is a flowchart of a tube inner wall coating method according to a first-second embodiment of the present disclosure.

With reference to FIG. 7, first, the user may mount the tube 2 on the tube mounting part 20 and fix the tube 2 (S11).

Thereafter, the user may pre-store the normal spray rate range of the coating liquid, the sliding movement speed of the spray pipe 32, and the rotational speed of the spray nozzle 34, which are matched with the viscosity of the coating liquid and the diameter (size) of the hollow portion of the tube 2, in the storage part (S12).

Thereafter, the viscosity detection part 40 may detect the viscosity of the coating liquid, and thereafter or at the same time, the camera 50 may be inserted into the tube 2 and then acquire the image of the inner wall of the tube 2 (S13).

Thereafter, the controller 80 may calculate the diameter of the hollow portion of the tube 2 by analyzing the image of the inner wall of the tube 2 acquired from the camera 50 (S14).

Thereafter, in order to form the coating layer with a predetermined thickness on the inner wall of the tube 2 formed with the hollow portion, the controller 80 may control the spray nozzle 34 so that the spray nozzle 34 sprays the coating liquid within the normal spray rate range of the coating liquid pre-stored in the storage part (not illustrated) and matched with the viscosity of the coating liquid detected by the viscosity detection part 40 and the diameter of the hollow portion calculated based on the image of the inner wall of the tube 2 (S15).

Thereafter, in order to form the coating layer with a predetermined thickness on the inner wall of the tube 2 formed with the hollow portion, the controller 80 may control the first sliding driving part 36 and the nozzle rotation driving part 37 so that the spray pipe 32 slides and the spray nozzle 34 rotates at the sliding movement speed of the spray pipe 32 and the rotational speed of the spray nozzle 34 pre-stored in the storage part (not illustrated) and matched with the viscosity of the coating liquid detected by the viscosity detection part 40 and the diameter of the hollow portion calculated based on the image of the inner wall of the tube 2 (S16).

Thereafter, the spray nozzle 34 may be inserted into the tube 2 and then spray the coating liquid toward the inner wall of the tube 2 in accordance with the normal spray rate range, the sliding movement speed of the spray pipe 32, and the rotational speed of the spray nozzle 34 that are pre-stored in the storage part (not illustrated) by the controller 80 (S17).

### First-Third Embodiment

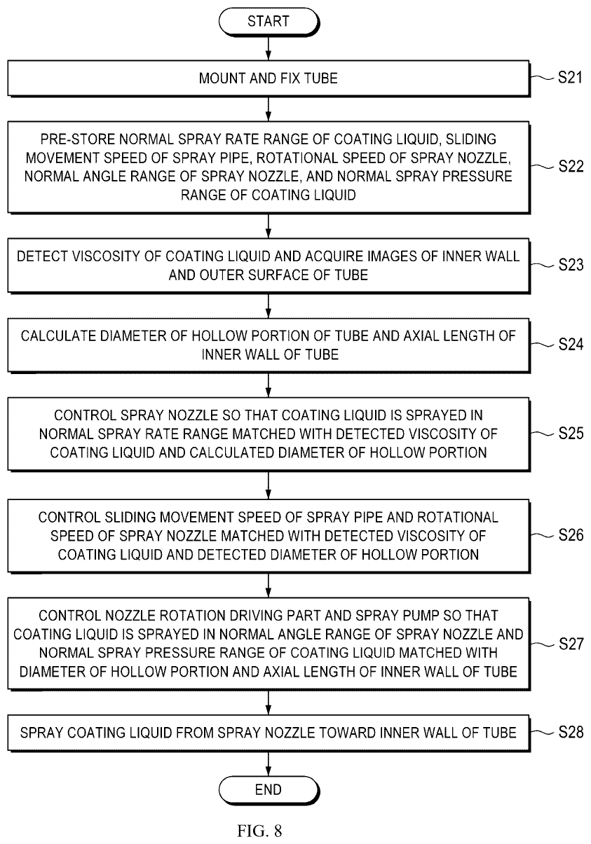

FIG. 8 is a flowchart of a tube inner wall coating method according to a first-third embodiment of the present disclosure.

With reference to FIG. 8, first, the user may mount the tube 2 on the tube mounting part 20 and fix the tube 2 (S21).

Thereafter, the user may pre-store the normal spray rate range of the coating liquid, the sliding movement speed of the spray pipe 32, and the rotational speed of the spray nozzle 34, which are matched with the viscosity of the coating liquid and the diameter (size) of the hollow portion of the tube 2, and the normal angle range of the spray nozzle 34 and the normal spray pressure range of the coating liquid, which are matched with the diameter of the hollow portion of the tube 2 and the axial length of the inner wall of the tube 2, in the storage part (S22).

Thereafter, the viscosity detection part 40 may detect the viscosity of the coating liquid, and thereafter or at the same time, the camera 50 may be inserted into the tube 2 and then acquire the images of the inner wall and outer surface of the tube 2 (S23).

Thereafter, the controller 80 may calculate the diameter of the hollow portion of the tube 2 and the axial length of the inner wall of the tube 2 by analyzing the images of the inner wall and outer surface of the tube 2 acquired from the camera 50 (S24).

Thereafter, in order to form the coating layer with a predetermined thickness on the inner wall of the tube 2 formed with the hollow portion, the controller 80 may control the spray nozzle 34 so that the spray nozzle 34 sprays the coating liquid within the normal spray rate range of the coating liquid pre-stored in the storage part (not illustrated) and matched with the viscosity of the coating liquid detected by the viscosity detection part 40 and the diameter of the hollow portion calculated based on the image of the inner wall of the tube 2 (S25).

Thereafter, in order to form the coating layer with a predetermined thickness on the inner wall of the tube 2 formed with the hollow portion, the controller 80 may control the first sliding driving part 36 and the nozzle rotation driving part 37 so that the spray pipe 32 slides and the spray nozzle 34 rotates at the sliding movement speed of the spray pipe 32 and the rotational speed of the spray nozzle 34 pre-stored in the storage part (not illustrated) and matched with the viscosity of the coating liquid detected by the viscosity detection part 40 and the diameter of the hollow portion calculated based on the image of the inner wall of the tube 2 (S26).

Thereafter, in order to form the coating layer with a predetermined thickness on the inner wall of the tube 2 formed with the hollow portion, the controller 80 may control the nozzle rotation driving part 37 and the spray pump 35 so that the spray nozzle 34 sprays the coating liquid within the normal angle range of the spray nozzle 34 and the normal spray pressure range of the coating liquid pre-stored in the storage part (not illustrated) and matched with the diameter of the hollow portion of the tube 2 and the axial length of the inner wall of the tube 2 (S27).

Thereafter, the spray nozzle 34 may be inserted into the tube 2 and then spray the coating liquid toward the inner wall of the tube 2 in accordance with the normal spray rate range, the sliding movement speed of the spray pipe 32, the rotational speed of the spray nozzle 34, and the normal spray pressure range of the coating liquid that are pre-stored in the storage part (not illustrated) by the controller 80 (S28).

### First-Fourth Embodiment

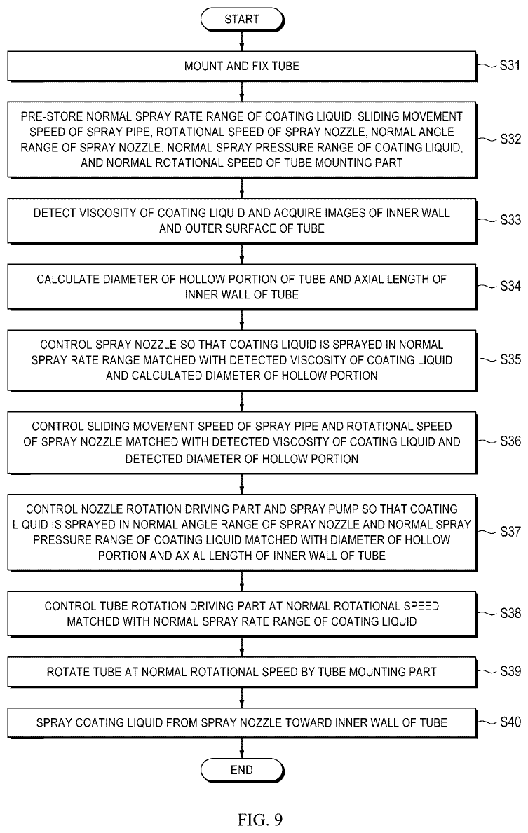

FIG. 9 is a flowchart of a tube inner wall coating method according to a first-fourth embodiment of the present disclosure.

With reference to FIG. 9, first, the user may mount the tube 2 on the tube mounting part 20 and fix the tube 2 (S31).

Thereafter, the user may store the normal spray rate range of the coating liquid, the sliding movement speed of the spray pipe 32, and the rotational speed of the spray nozzle 34, which are matched with the viscosity of the coating liquid and the diameter (size) of the hollow portion of the tube 2, the normal angle range of the spray nozzle 34 and the normal spray pressure range of the coating liquid, which are matched with the diameter of the hollow portion of the tube 2 and the axial length of the inner wall of the tube 2, and the normal rotational speed of the tube mounting part 20, which is matched with the normal spray rate range of the coating liquid, in the storage part (S32).

Thereafter, the viscosity detection part 40 may detect the viscosity of the coating liquid, and thereafter or at the same time, the camera 50 may be inserted into the tube 2 and then acquire the images of the inner wall and outer surface of the tube 2 (S33).

Thereafter, the controller 80 may calculate the diameter of the hollow portion of the tube 2 and the axial length of the inner wall of the tube 2 by analyzing the images of the inner wall and outer surface of the tube 2 acquired from the camera 50 (S34).

Thereafter, in order to form the coating layer with a predetermined thickness on the inner wall of the tube 2 formed with the hollow portion, the controller 80 may control the spray nozzle 34 so that the spray nozzle 34 sprays the coating liquid within the normal spray rate range of the coating liquid pre-stored in the storage part (not illustrated) and matched with the viscosity of the coating liquid detected by the viscosity detection part 40 and the diameter of the hollow portion calculated based on the image of the inner wall of the tube 2 (S35).

Thereafter, the controller 80 may control the first sliding driving part 36 and the nozzle rotation driving part 37 so that the spray pipe 32 slides and the spray nozzle 34 rotates at the sliding movement speed of the spray pipe 32 and the rotational speed of the spray nozzle 34 pre-stored in the storage part (not illustrated) and matched with the viscosity of the coating liquid detected by the viscosity detection part 40 and the diameter of the hollow portion calculated based on the image of the inner wall of the tube 2 (S36).

Thereafter, the controller 80 may control the nozzle rotation driving part 37 and the spray pump 35 so that the spray nozzle 34 sprays the coating liquid within the normal angle range of the spray nozzle 34 and the normal spray pressure range of the coating liquid pre-stored in the storage part (not illustrated) and matched with the diameter of the hollow portion of the tube 2 and the axial length of the inner wall of the tube 2 (S37).

Thereafter, the controller 80 may control the tube rotation driving part 60 so that the tube mounting part 20 rotates at the normal rotational speed pre-stored in the storage part (not illustrated) and matched with the normal spray rate range of the coating liquid when the spray nozzle 34 is controlled to spray the coating liquid within the normal spray rate range of the coating liquid (S38).

Thereafter, the tube 2 may rotate at the normal rotational speed pre-stored in the storage part (not illustrated) by the tube mounting part 20 (S39).

Thereafter, the spray nozzle 34 may be inserted into the tube 2 and then spray the coating liquid toward the inner wall of the tube 2, which rotates at the normal rotational speed, in accordance with the normal spray rate range, the sliding movement speed of the spray pipe 32, the rotational speed of the spray nozzle 34, and the normal spray pressure range of the coating liquid that are pre-stored in the storage part (not illustrated) by the controller 80 (S40).

### First-Fifth Embodiment

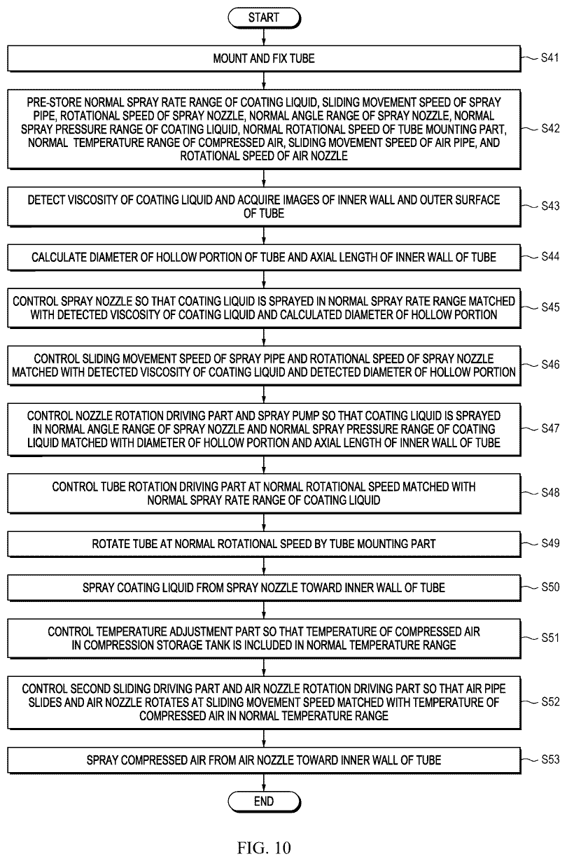

FIG. 10 is a flowchart of a tube inner wall coating method according to a first-fifth embodiment of the present disclosure.

With reference to FIG. 10, first, the user may mount the tube 2 on the tube mounting part 20 and fix the tube 2 (S41).

Thereafter, the user may store the normal spray rate range of the coating liquid, the sliding movement speed of the spray pipe 32, and the rotational speed of the spray nozzle 34, which are matched with the viscosity of the coating liquid and the diameter (size) of the hollow portion of the tube 2, the normal angle range of the spray nozzle 34 and the normal spray pressure range of the coating liquid, which are matched with the diameter of the hollow portion of the tube 2 and the axial length of the inner wall of the tube 2, the normal rotational speed of the tube mounting part 20, which is matched with the normal spray rate range of the coating liquid, the normal temperature range of the compressed air in the compression storage tank 72, and the sliding movement speed of the air pipe 73 and the rotational speed of the air nozzle 75, which are matched with the normal temperature range of the compressed air, in the storage part (S42).

Thereafter, the viscosity detection part 40 may detect the viscosity of the coating liquid, and thereafter or at the same time, the camera 50 may be inserted into the tube 2 and then acquire the images of the inner wall and outer surface of the tube 2 (S43).

Thereafter, the controller 80 may calculate the diameter of the hollow portion of the tube 2 and the axial length of the inner wall of the tube 2 by analyzing the images of the inner wall and outer surface of the tube 2 acquired from the camera 50 (S44).

Thereafter, in order to form the coating layer with a predetermined thickness on the inner wall of the tube 2 formed with the hollow portion, the controller 80 may control the spray nozzle 34 so that the spray nozzle 34 sprays the coating liquid within the normal spray rate range of the coating liquid pre-stored in the storage part (not illustrated) and matched with the viscosity of the coating liquid detected by the viscosity detection part 40 and the diameter of the hollow portion calculated based on the image of the inner wall of the tube 2 (S45).

Thereafter, the controller 80 may control the first sliding driving part 36 and the nozzle rotation driving part 37 so that the spray pipe 32 slides and the spray nozzle 34 rotates at the sliding movement speed of the spray pipe 32 and the rotational speed of the spray nozzle 34 pre-stored in the storage part (not illustrated) and matched with the viscosity of the coating liquid detected by the viscosity detection part 40 and the diameter of the hollow portion calculated based on the image of the inner wall of the tube 2 (S46).

Thereafter, the controller 80 may control the nozzle rotation driving part 37 and the spray pump 35 so that the spray nozzle 34 sprays the coating liquid within the normal angle range of the spray nozzle 34 and the normal spray pressure range of the coating liquid pre-stored in the storage part (not illustrated) and matched with the diameter of the hollow portion of the tube 2 and the axial length of the inner wall of the tube 2 (S47).

Thereafter, the controller 80 may control the tube rotation driving part 60 so that the tube mounting part 20 rotates at the normal rotational speed pre-stored in the storage part (not illustrated) and matched with the normal spray rate range of the coating liquid when the spray nozzle 34 is controlled to spray the coating liquid within the normal spray rate range of the coating liquid (S48).

Thereafter, the tube 2 may rotate at the normal rotational speed pre-stored in the storage part (not illustrated) by the tube mounting part 20 (S49).

Thereafter, the spray nozzle 34 may be inserted into the tube 2 and then spray the coating liquid toward the inner wall of the tube 2, which rotates at the normal rotational speed, in accordance with the normal spray rate range, the sliding movement speed of the spray pipe 32, the rotational speed of the spray nozzle 34, and the normal spray pressure range of the coating liquid that are pre-stored in the storage part (not illustrated) by the controller 80 (S50).

Thereafter, in case that the temperature detected by the temperature sensor 76 deviates from the normal temperature range after the spray nozzle 34 departs from the inside of the tube 2 to the outside when a predetermined time elapses after the coating liquid is sprayed, the controller 80 may control the temperature adjustment part 77 so that the temperature of the compressed air in the compression storage tank 72 is included in the normal temperature range pre-stored in the storage part (not illustrated) (S51).

Thereafter, in order to cure the coating layer with a predetermined thickness on the inner wall of the tube 2 formed with the hollow portion, the controller 80 may control the second sliding driving part (not illustrated) and the air nozzle rotation driving part 78 so that the air pipe 73 slides and the air nozzle 75 rotates at the sliding movement speed pre-stored in the storage part (not illustrated) and matched with the temperature of the compressed air within the normal temperature range detected by the temperature sensor 76 (S52).

Thereafter, the air nozzle 75 may be inserted into the tube 2 and then spray the compressed air toward the inner wall of the tube 2, which rotates at the normal rotational speed, in accordance with the sliding movement speed of the air pipe 73 and the rotational speed of the air nozzle 75 pre-stored in the storage part (not illustrated) by the controller 80 (S53).

### Tube Inner Wall Coating Apparatus and Operation of Second Embodiment

### 1) Configuration of Tube Inner Wall Coating Apparatus of Second Embodiment

Hereinafter, a tube inner wall coating apparatus 5 according to another embodiment of the present disclosure will be described in detail with reference to the accompanying drawings.

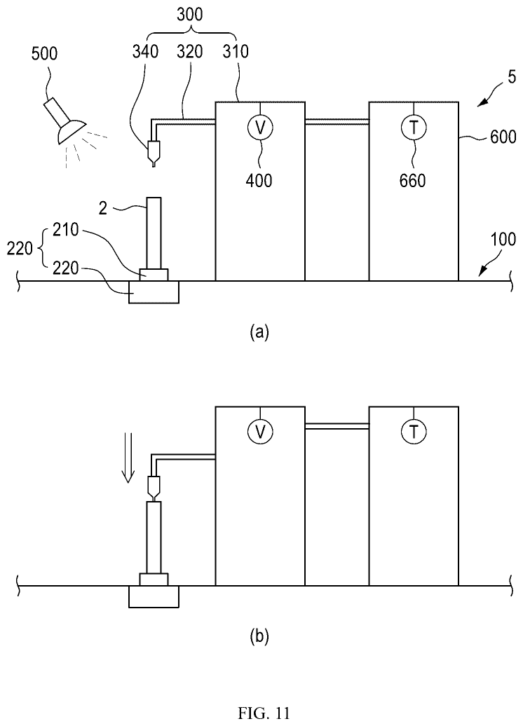

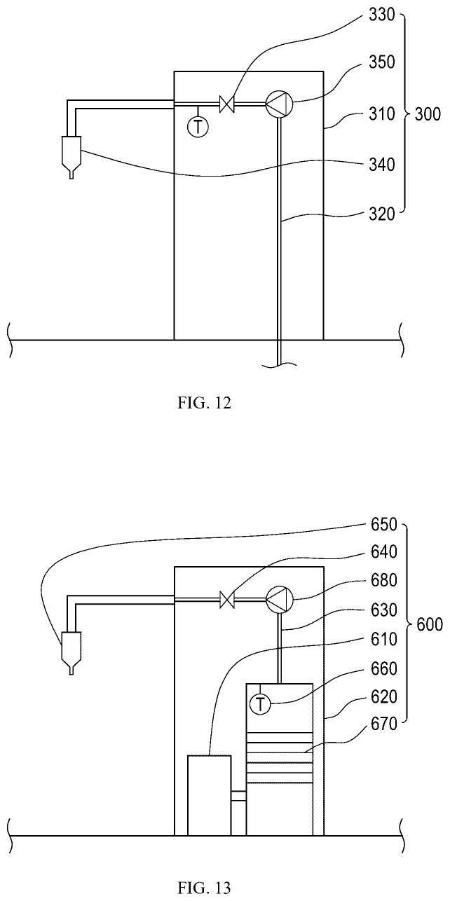

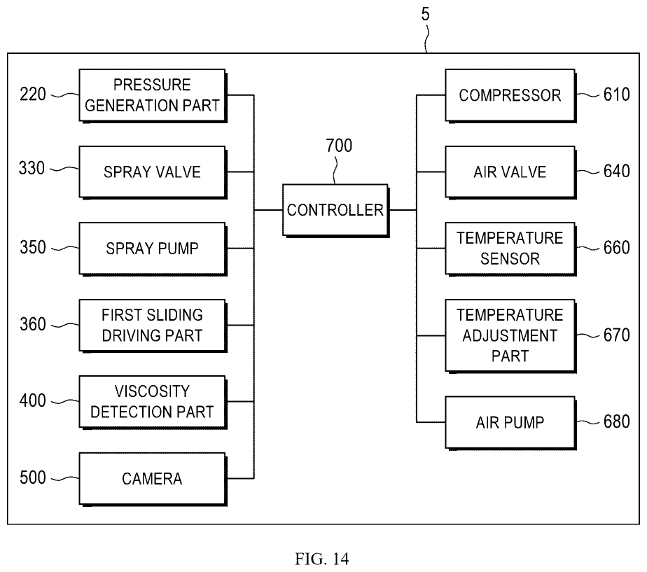

FIG. 11 is an exemplified view of a tube inner wall coating apparatus according to another embodiment of the present disclosure, FIG. 12 is an exemplified view of a coating liquid spray part according to another embodiment of the present disclosure, FIG. 13 is an exemplified view of an air spray part according to another embodiment of the present disclosure, and FIG. 14 is a control block diagram of a controller according to another embodiment of the present disclosure.

With reference to FIG. 11, the tube inner wall coating apparatus 5 according to another embodiment of the present disclosure is an apparatus that uniformly sprays the coating liquid and the compressed air onto the inner wall of the tube 2 formed with the hollow portion, and the tube inner wall coating apparatus 5 includes a base part 100, a tube mounting part 200, a coating liquid spray part 300, a viscosity detection part 400, a camera 500, an air spray part 600, a controller 700, and a storage part (not illustrated).

In another embodiment, the base part 100 may be configured to support the pressure adjustment part 200, the coating liquid spray part 300, the viscosity detection part 400, the camera 500, the air spray part 600, and the controller 700 and have legs and an upper plate on which processes are performed.

In another embodiment, the pressure adjustment part 200 is disposed on an upper portion of the base part 100. The pressure adjustment part 200 includes a fixing part 210 configured to fix a position of the tube 2 formed with the hollow portion while the coating liquid and the compressed air are sprayed onto the inner wall of the tube 2 formed with the hollow portion, and a pressure generation part 220 configured to apply pressure into the tube 2 while the coating liquid is sprayed toward the inner wall of the tube 2.

In this case, the tube 2 may be a cylindrical hollow fiber membrane formed with a hollow portion and having a circular cross-section.

In another embodiment, the fixing part 210 may be supported by the base part 100 and fix the position of the tube 2 formed with the hollow portion to the upper portion of the base part 100 in a state in which the fixing part 210 holds the distal end region of the tube 2 formed with the hollow portion.

In addition, the fixing part 210 is maintained in a state in which the fixing part 210 is larger in diameter than the tube 2 to mount the position of the tube 2 formed with the hollow portion. When the tube 2 needs to be fixed, the fixing part 210 may be adjusted to suit the diameter of the tube 2, such that the fixing part 210 may fix the position of the tube 2 in the state in which the fixing part 210 holds the distal end region of the tube 2.

Further, although not illustrated in the drawings, a pressure detection sensor (not illustrated), which is configured to be inserted into the tube 2 through the hollow portion of the tube 2 when the tube 2 is mounted, may be provided at an upper end of the fixing part 210, which is configured to come into contact with the distal end region of the tube 2, and detect internal pressure of the tube 2.

In this case, the pressure detection sensor of the fixing part 210 may be implemented as at least one of a micro-piezoelectric sensor, a micro-capacity pressure sensor, a MEMS pressure sensor, an optical fiber pressure sensor, or a strain gauge pressure sensor.

In another embodiment, the pressure generation part 220 may be provided on the fixing part 210 configured to come into contact with the distal end region of the tube 2 held by the fixing part 210. When the position of the tube 2 is fixed as the distal end region of the tube 2 is held by the fixing part 210, pressure may be applied to the hollow portion of the tube 2 from the distal end region of the tube 2, thereby inducing the coating liquid, which is sprayed onto the inner wall of the tube 2, to flow toward the distal end region of the tube 2.

In addition, the pressure generation part 220 may generate negative pressure in the tube 2 by applying pressure into the tube 2 as the hollow portion of the tube 2 is sealed by the upper end of the fixing part 210 and the spray nozzle 340 when the spray nozzle 340 to be described below is inserted into the tube 2 to spray the coating liquid toward the inner wall of the tube 2.

Further, the pressure generation part 220 may generate negative pressure in the tube 2 by generating a pressure difference between an upper end of the tube 2 including one side of the hollow portion of the tube 2, into which the spray nozzle 340 is inserted, and a lower end of the tube 2 including the distal end region of the tube 2, thereby inducing the flow of the coating liquid in accordance with the pressure difference between the upper end of the tube 2 and the lower end of the tube 2.

More specifically, the pressure generation part 220 may induce the coating liquid, which is sprayed toward the inner wall of the tube 2, to flow toward the distal end region of the tube 2 by applying pressure into the tube 2 so that the pressure (e.g., 1.5 bar) at the upper end of the tube 2 is higher than the pressure (e.g., 0.5 bar) at the lower end of the tube 2. The coating liquid may move toward the distal end region of the tube 2 along the inner wall of the tube 2 under a negative pressure condition, thereby uniformly coating the inner wall of the tube 2.

The pressure generation part 220 may apply the pressure into the tube 2 so that the internal pressure of the tube 2 increases from a time point at which the coating liquid is sprayed toward the inner wall of the tube 2 by the controller 700 to a time point at which the coating process ends.

In another embodiment, the coating liquid spray part 300 may be supported on the base part 100 and spray the coating liquid onto the inner wall of the tube 2 mounted on the tube mounting part 200.

With reference to FIG. 12, in order to spray the coating liquid onto the inner wall of the tube 2 formed with the hollow portion, the coating liquid spray part 300 includes a spray main body 310, a spray pipe 320, a spray valve 330, a spray nozzle 340, a spray pump 350, and a first sliding driving part 360.

In another embodiment, the spray main body 310 is formed with an accommodation space for accommodating therein the spray pipe 320, the spray valve 330, the spray nozzle 340, the spray pump 350, and the first sliding driving part 360. In some instances, the spray main body 310 may be separated from the base part 100 to perform maintenance of the inside of the spray main body 310.

In another embodiment, the spray pipe 320 may have a distal end region coupled to the spray main body 310 so that the spray pipe 320 is slidable in an upward or downward direction. A conduit may be formed in the spray pipe 320 to provide a movement route for moving the coating liquid to the spray nozzle 340.

In addition, a conduit of the spray pipe 320 may be connected to a pressure adjustment system, which is controlled by the controller 700, and supply the coating liquid into the spray nozzle 340 at a predetermined rate. A sealing device may be included to prevent the coating liquid from leaking to the outside during the process of supplying the coating liquid to the spray nozzle 340, thereby maintaining a sealed state in order to prevent the coating liquid from leaking even while the rotary shaft rotates.

In another embodiment, the spray valve 330 may be disposed on the spray pipe 320. The movement route of the spray pipe 320 may be opened or closed to allow the coating liquid to move along the spray pipe 320 or block the movement of the coating liquid.

In addition, although not illustrated in the drawings, the spray valve 330 may be a small-scale cylindrical valve, and a precise spring may be embedded in the spray valve 330. A flow rate of the coating liquid may be adjusted by elastically adjusting the spring.

Further, the spray valve 330 may be equipped with a variable slit that may be adjusted at a level of several micrometers in order to maintain a predetermined flow of the coating liquid, thereby adjusting pressure of the coating liquid.

The spray valve 330 may be implemented as an electronic control-type valve. The spray valve 330 may be configured to open the movement route of the spray pipe 320 when the controller 700 controls the spray nozzle 340 so that the spray nozzle 340 sprays the coating liquid from the spray nozzle 340 within a normal spray rate range of the coating liquid, and the spray valve 330 may be configured to close the movement route of the spray pipe 320 before the controller 700 controls the spray nozzle 340.

In another embodiment, the spray nozzle 340 may be coupled to the distal end region of the spray pipe 320 that may be inserted into the tube 2 formed with the hollow portion, and a coating liquid discharge part (not illustrated) may be provided in the distal end region and have one or more discharge ports configured to spray the coating liquid, which moves along the movement route formed in the spray pipe 320, toward the inner wall of the tube 2 formed with the hollow portion.

In addition, the spray nozzle 340 has a shape that is narrowed from one end connected to the spray pipe 320 toward the other end provided with the coating liquid discharge part while corresponding to the shape of the hollow portion of the tube 2, such that the other end provided with the coating liquid discharge part may be inserted into the tube 2.

Further, the distal end region of the spray nozzle 340 provided with the coating liquid discharge part (not illustrated) may be inserted into the tube 2 formed with the hollow portion by the sliding movement of the spray pipe 320. In this case, the distal end region of the spray nozzle 340 may seal the hollow portion of the tube 2 in order to generate the negative pressure in the tube 2 formed with the hollow portion.

In addition, the inside of the spray nozzle 340 may be smoothly coated to prevent residue of a coating solution from accumulating in the conduit configured to move the coating liquid. The spray nozzle 340 may be narrowed from one end, at which the coating liquid is received from the spray pipe 320, to the other end, at which the coating liquid is discharged, and the spray nozzle 340 may have a structure that is gradually narrowed. Therefore, the spray nozzle 340 may accelerate the flow of the coating liquid, thereby spraying the coating liquid in the form of fine fog (or mist).

Further, the spray nozzle 340 may be provided with a small rotary disc provided at the other end of the conduit, or a fine swirl pattern may be engraved at the other end of the conduit, thereby imparting a fine rotational force when the coating liquid is sprayed. Therefore, the spray nozzle 340 may enable the coating liquid to uniformly spread at a wide angle when the spray nozzle 340 sprays the coating liquid, and a small protruding portion is formed at an end of the spray nozzle 340, which communicates with the other end of the conduit, such that the coating liquid may be immediately sprayed without accumulating.

Additionally, the spray nozzle 340 may be made of stainless steel or ceramic material, thereby ensuring durability and maintaining precise spray performance.

In another embodiment, the spray pump 350 may be disposed on the spray pipe 320 and apply pressure to the coating liquid so that the coating liquid moves along the movement route formed in the spray pipe 320.

Although not illustrated in the drawings, the spray pump 350 may have a compact rectangular parallelepiped shape and have a structure in which a piston moves rectilinearly. In this case, the piston may precisely push the coating liquid while applying pressure to the coating liquid, thereby maintaining constant pressure for moving the coating liquid.

Furthermore, the spray pump 350 may be coated with a corrosion-resistant coating, thereby preventing damage (or corrosion) caused by chemical properties of the coating liquid.

In another embodiment, in order to coat the inner wall of the tube 2 formed with the hollow portion, the first sliding driving part 360 may slide the spray nozzle 340 provided in the distal end region of the spray pipe 320 so that the spray nozzle 340 provided in the distal end region of the spray pipe 320 departs from the inside of the tube 2 to the outside when a process of inserting the spray nozzle 340 provided in the distal end region of the spray pipe 320 into the tube 2 or a process of coating the inner wall of the tube 2 ends.

That is, the spray nozzle 340 may be slid upward or downward from the inside of the tube 2 by the first sliding driving part 360 during the coating process of coating the inner wall of the tube 2.

In another embodiment, the viscosity detection part 400 may be connected to the coating liquid spray part 300 through the spray main body 310 and detect viscosity of the coating liquid, which moves along the spray pipe 320, before the coating liquid is sprayed from the spray nozzle 340.

In this case, the viscosity detection part 400 may be implemented as at least one of a rotary viscometer configured to calculate viscosity by measuring resistance torque applied to a rotating spindle in the coating liquid, a vibrational viscometer configured to calculate viscosity from a change in energy required for the coating liquid to maintain a predetermined frequency, a resonance-type viscosity sensor configured to detect viscosity based on a change in resonant frequency measured by using a piezoelectric element, a tubular viscometer configured to measure viscosity based on the time for which the coating liquid passes through an internal conduit (tube), or an ultrasonic-based viscometer configured to measure viscosity in a contactless manner by using a propagation speed or damping characteristics of ultrasonic waves transmitted to the coating liquid.

In another embodiment, the camera 500 may acquire images of the inner wall and outer surface of the tube 2 by capturing an image of the inner wall of the tube 2 formed with the hollow portion and an image of the outer surface of the tube 2 mounted on the tube mounting part 200 before the inner wall of the tube 2 is coated. The camera 500 may transmit the acquired image of the inner wall of the tube 2 and the acquired image of the outer surface of the tube 2 to the controller 700.

In addition, in order to acquire the image of the inner wall of the tube 2, the camera 500 may be inserted into the tube 2 through the hollow portion of the tube 2 and acquire the image of the inner wall of the tube 2 before the spray nozzle 340 is inserted into the tube 2.

Further, when the spray nozzle 340 departs from the inside of the tube 2 to the outside after the coating layer is formed on the inner wall of the tube 2, the camera 500 may be inserted into the tube 2 again and acquire an image of the inner wall of the tube 2 on which the coating layer is formed.

That is, in the present disclosure, the image of the inner wall of the tube 2 refers to an image acquired by capturing, in real time, an image of the inner wall of the tube 2 before the inner wall of the tube 2 is coated with the coating liquid and by capturing, in real time, an image of the inner wall of the tube 2 coated with the coating liquid.

The type of camera 500 is not limited as long as the camera 500 may capture an image of the inside of the tube 2. In order to capture an image of the inside of the narrow tube 2, the camera 500 may be implemented as at least one of a borescope integrally equipped with a small-scale lens and a light source (LED), a fiberscope using an optical fiber bundle, a miniature CMOS/CCD module including a small-scale CMOS or CCD sensor, or a 360-degree endoscopic camera.

In another embodiment, the air spray part 600 is supported by the base part 100 and configured to cure the coating layer by spraying compressed air toward the inner wall of the tube 2 on which the coating layer is formed as the tube 2 is mounted on the tube mounting part 200 and then coated with the coating liquid. FIG. 3 illustrates constituent elements for implementing this configuration.

With reference to FIG. 13, the air spray part 600 includes a compressor 610, a compression storage tank 620, an air pipe 630, an air valve 640, a second sliding driving part (not illustrated), an air nozzle 650, a temperature sensor 660, a temperature adjustment part 670, and an air pump 680.

In another embodiment, the compressor 610 may produce compressed air by compressing outside air.

In this case, the compressor 610 may be implemented as at least one of a reciprocating compressor configured to compress outside air by using a rectilinear reciprocating motion of a piston, a screw compressor configured to compress outside air by using two rotating screw rotors, a Roots-type compressor configured to compress outside air by using two rotating rotors, a scroll compressor configured to compress outside air by using two spiral scrolls, or a centrifugal compressor configured to compress outside air by using a rotating impeller.

In another embodiment, the compression storage tank 620 may be connected to the compressor 610 and store compressed air discharged from the compressor 610.

In another embodiment, the air pipe 630 may be connected to the compression storage tank 620, and a conduit may be formed in the air pipe 630 to provide a movement route for moving the compressed air to the air nozzle 650.

In addition, the conduit of the air pipe 630 may be connected to the pressure adjustment system, which is controlled by the controller 700, and supply the compressed air into the air nozzle 650 at a predetermined rate. A sealing device may be included to prevent the compressed air from leaking to the outside during the process of supplying the compressed air to the air nozzle 650, thereby maintaining a sealed state in order to prevent the compressed air from leaking even while the rotary shaft rotates.

In another embodiment, the air valve 640 may be disposed on the air pipe 630. The movement route of the air pipe 630 may be opened or closed to allow the compressed air to move along the air pipe 630 or block the movement of the compressed air.

The air valve 640 may be implemented as an electronic control-type valve that opens the movement route of the air pipe 630, when a temperature of the compressed air detected by the temperature sensor 660 is included in a normal temperature range, and closes the movement route of the air pipe 630 when the temperature of the compressed air is not included in the normal temperature range.

In another embodiment, in order to cure the coating layer with a predetermined thickness on the inner wall of the tube 2 formed with the hollow portion, the second sliding driving part (not illustrated) may slide the air nozzle 650, which is provided in the distal end region of the air pipe 630, so that the air nozzle 650 provided in the distal end region of the air pipe 630 departs from the inside of the tube 2 to the outside when the process of inserting the air nozzle 650 provided in the distal end region of the air pipe 630 into the tube 2 or the process of curing the inner wall of the tube 2 ends.

That is, the air nozzle 650 may be slid upward or downward from the inside of the tube 2 by the second sliding driving part (not illustrated) during the curing process of curing the coating layer formed on the inner wall of the tube 2.

In another embodiment, the air nozzle 650 may be coupled to the distal end region of the air pipe 630 that may be inserted into the tube 2 formed with the hollow portion, and a compressed air discharge part (not illustrated) may be provided in the distal end region and have one or more discharge ports configured to spray the compressed air, which moves along the movement route formed in the air pipe 630, toward the inner wall of the tube 2 formed with the hollow portion.

In addition, the air nozzle 650 has a shape that is narrowed from one end connected to the spray pipe 320 toward the other end provided with the coating liquid discharge part while corresponding to the shape of the hollow portion of the tube 2, such that the other end provided with the compressed air discharge part may be inserted into the tube 2.

Further, the distal end region of the air nozzle 650 provided with the compressed air discharge part (not illustrated) may be inserted into the tube 2 formed with the hollow portion by the sliding movement of the air pipe 630. In this case, the distal end region of the air nozzle 650 may seal the hollow portion of the tube 2 so that the compressed air does not leak to the outside.

In another embodiment, the compressed air sprayed from the air nozzle 650 may be cooled compressed air that may not only uniformly cure the coating layer formed on the inner wall of the tube 2, but also shorten a period of time for the curing process.

To this end, the compression storage tank 620 may be provided with a temperature adjustment means (not illustrated) that may not only store the compressed air, but also cool the compressed air. The temperature adjustment means may be operated by the controller 700 and cool the compressed air.

In addition, in order to move the cooled compressed air, the air pipe 630 may be made of a material (e.g., stainless steel, Teflon, etc.) that prevents an inner wall of the conduit, which constitutes the movement route, from being frozen by the cooled compressed air.

In another embodiment, the temperature sensor 660 may be disposed in the compression storage tank 620 and detect a temperature of the compressed air stored in the compression storage tank 620.

The temperature sensor 660 may detect the temperature of the compressed air based on at least one of a thermal resistance method of measuring a temperature by using a property that resistance varies depending on a change in temperature of metal, a thermocouple method of measuring a temperature by using a thermoelectromotive force generated by joining two different types of metal, a thermistor method of measuring a temperature based on resistance that varies depending on the temperature, or an infrared non-contact method of measuring a temperature based on infrared radiant energy emitted from a surface of compressed air.

In another embodiment, the temperature adjustment part 670 may be disposed in the compression storage tank 620 and adjust the temperature of the compressed air stored in the compression storage tank 620.

Although not illustrated in the drawings, the temperature adjustment part 670 may include an electric heater (not illustrated) configured to raise a temperature of the compression storage tank 620, a cooler (not illustrated) containing a coolant for cooling high-temperature compressed air with a temperature raised by the electric heater, and a heat exchanger (not illustrated) configured to cool the coolant of the cooler.

In another embodiment, the air pump 680 may be disposed on the air pipe 630 and apply pressure to the compressed air so that the compressed air moves along the movement route formed in the air pipe 630.

Although not illustrated in the drawings, the air pump 680 may have a compact rectangular parallelepiped shape and have a structure in which a piston moves rectilinearly. In this case, the piston may precisely push the compressed air while applying pressure to the compressed air, thereby maintaining constant pressure for moving the compressed air.

With reference to FIG. 14, in order to form the coating layer with a predetermined thickness on the inner wall of the tube 2 formed with the hollow portion, in case that the normal spray rate range (e.g., 0.3 to 1.0 mL/sec) of the coating liquid, which is matched with at least one of the viscosity of the coating liquid and the diameter (size) of the hollow portion, is pre-stored in the storage part (not illustrated) and the diameter of the hollow portion of the tube 2 is calculated by analyzing the image of the inner wall of the tube 2 acquired from the camera 500 while the viscosity detection part 400 detects the viscosity of the coating liquid, the controller 700 may control the spray nozzle 340 so that the coating liquid is sprayed from the spray nozzle 340 within the normal spray rate range of the coating liquid pre-stored in the storage part (not illustrated) matched with at least one of the viscosity of the coating liquid detected by the viscosity detection part 400 and the diameter of the hollow portion calculated based on the image of the inner wall of the tube 2.

In a specific example, in case that the diameter of the hollow portion of the tube 2 is 10 mm and the viscosity of the coating liquid is 100 cp, the controller 700 may control the spray nozzle 340 so that the spray nozzle 340 sprays the coating liquid at a spray rate of 0.6 mL/sec.

In addition, in order to form the coating layer with a predetermined thickness on the inner wall of the tube 2 formed with the hollow portion, in case that the normal internal pressure range (e.g., 0.2 to 1.8 bar, etc.) of the tube 2, which may induce the coating liquid to flow to the distal end region of the tube 2, is pre-stored in the storage part (not illustrated) and the pressure detection sensor (not illustrated) of the fixing part 210 detects the internal pressure of the tube 2, the controller 700 may control the pressure generation part 220 so that the internal pressure of the tube 2 detected by the pressure detection sensor (not illustrated) is adjusted within the normal internal pressure range of the tube 2.

In this case, the normal internal pressure range of the tube 2 may vary depending on the diameter of the hollow portion of the tube 2. Therefore, the normal internal pressure range of the tube 2 may be matched with the diameter of the hollow portion of the tube 2.

Further, in order to form the coating layer with a predetermined thickness on the inner wall of the tube 2 formed with the hollow portion, in case that a normal spray pressure range (e.g., 0.5 to 2.0 bar) of the coating liquid, which is matched with the diameter of the hollow portion of the tube 2 and the axial length of the inner wall of the tube 2, is pre-stored in the storage part (not illustrated) and the diameter of the hollow portion of the tube 2 and the axial length of the inner wall of the tube 2 are calculated by analyzing the images of the inner wall and outer surface of the tube 2 acquired from the camera 500, the controller 700 may control the spray pump 350 so that the coating liquid is sprayed from the spray nozzle 340 within the normal spray pressure range of the coating liquid pre-stored in the storage part (not illustrated) and matched with the diameter of the hollow portion of the tube 2 and the axial length of the inner wall of the tube 2 calculated based on the images of the inner wall and outer surface of the tube 2.

In a specific example, in case that the diameter of the hollow portion of the tube 2 is 10 mm and the axial length of the inner wall of the tube 2 is 300 mm, the controller 700 may control the spray pump 350 so that the spray nozzle 340 sprays the coating liquid at 1.5 bar.

Further, in order to form the coating layer with a predetermined thickness on the inner wall of the tube 2 formed with the hollow portion, in case that a normal coating time (e.g., 3 to 25 seconds, etc.) of the spray nozzle 340, which is matched with the viscosity of the coating liquid and the diameter of the hollow portion, is pre-stored in the storage part (not illustrated) and the diameter of the hollow portion of the tube 2 is calculated by analyzing the image of the inner wall of the tube 2 acquired from the camera 500 while the viscosity detection part 400 detects the viscosity of the coating liquid, the controller 700 may control the spray nozzle 340 so that the spray nozzle 340 sprays the coating liquid for the normal coating time pre-stored in the storage part (not illustrated) and matched with the viscosity of the coating liquid detected by the viscosity detection part 400 and the diameter of the hollow portion calculated based on the image of the inner wall of the tube 2.

In a specific example, in case that the diameter of the hollow portion of the tube 2 is 10 mm and the viscosity of the coating liquid is 100 cp, the controller 700 may control the spray nozzle 340 so that the spray nozzle 340 sprays the coating liquid for the time of 3 to 5 seconds.

In addition, in order to cure the coating layer with a predetermined thickness on the inner wall of the tube 2 formed with the hollow portion, in case that the normal temperature range (e.g., 30 to 50° C.) of the compressed air in the compression storage tank 620 is pre-stored in the storage part (not illustrated) and the temperature detected by the temperature sensor 660 deviates from the normal temperature range, the controller 700 may control the temperature adjustment part 670 so that the temperature of the compressed air in the compression storage tank 620 is included in the normal temperature range pre-stored in the storage part (not illustrated).

In a specific example, the controller 700 may control the temperature adjustment part 670 so that the temperature of the compressed air in the compression storage tank 620, which is detected by the temperature sensor 660, is 40° C.

The controller 700 may include an electronic control circuit configured to control the constituent elements based on information transferred from the constituent elements illustrated in FIG. 13.

Furthermore, the controller 700 may be connected to the storage part (not illustrated) to control the operations of the constituent elements illustrated in FIG. 13. Although not illustrated in the drawings, a small-scale LED display (not illustrated) may be mounted on an outer portion of the controller 700.

In this case, the small-scale LED display (not illustrated) of the controller 700 may output and display the normal spray rate range of the coating liquid, the normal internal pressure range of the tube 2, the normal spray pressure range of the coating liquid, the normal coating time of the spray nozzle 340, and the normal temperature range of the compressed air that are pre-stored in the storage part (not illustrated). The entity, which pre-stores the pieces of information in the storage part (not illustrated), may be a user of the tube inner wall coating apparatus 5 using pressure or a manager who supervises the operations of coating and curing the tube 2 formed with the hollow portion.

### 2) Operation of Tube Inner Wall Coating Apparatus of Second Embodiment

Hereinafter, a tube inner wall coating method using pressure according to the embodiment of the present disclosure performed by the tube inner wall coating apparatus 5 of another embodiment will be described in detail with reference to the accompanying drawings.

### Second-First Embodiment

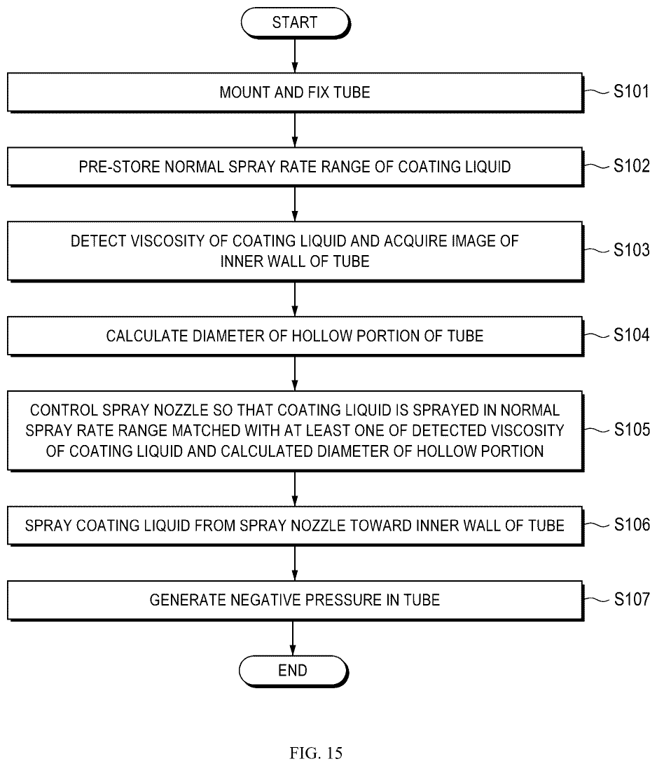

FIG. 15 is a flowchart of a tube inner wall coating method according to a second-first embodiment of the present disclosure.

With reference to FIG. 15, first, the user may mount the tube 2 on the tube mounting part 200 and fix the tube 2 (S101).

Thereafter, the user may pre-store the normal spray rate range of the coating liquid, which is matched with at least one of the viscosity of the coating liquid and the diameter (size) of the hollow portion of the tube 2, in the storage part (S102).

Thereafter, the viscosity detection part 400 may detect the viscosity of the coating liquid, and thereafter or at the same time, the camera 500 may be inserted into the tube 2 and then acquire the image of the inner wall of the tube 2 (S103).

Thereafter, the controller 700 may calculate the diameter of the hollow portion of the tube 2 by analyzing the image of the inner wall of the tube 2 acquired from the camera 500 (S104).

Thereafter, in order to form the coating layer with a predetermined thickness on the inner wall of the tube 2 formed with the hollow portion, the controller 700 may control the spray nozzle 340 so that the spray nozzle 340 sprays the coating liquid within the normal spray rate range of the coating liquid pre-stored in the storage part (not illustrated) and matched with at least one of the viscosity of the coating liquid detected by the viscosity detection part 400 and the diameter of the hollow portion calculated based on the image of the inner wall of the tube 2 (S105).

Thereafter, the spray nozzle 340 may be inserted into the tube 2 and then spray the coating liquid toward the inner wall of the tube 2 within the normal spray rate range pre-stored in the storage part (not illustrated) by the controller 700 (S106).

Thereafter, the pressure generation part 220 may generate the negative pressure in the tube 2 and induce the coating liquid to flow to the distal end region of the tube 2 (S107).

### Second-Second Embodiment

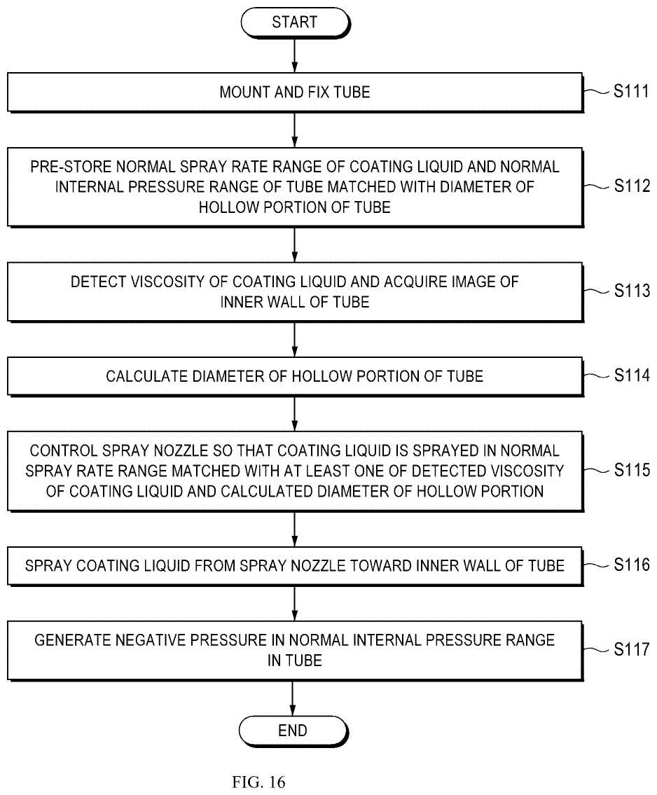

FIG. 16 is a flowchart of a tube inner wall coating method according to a second-second embodiment of the present disclosure.

With reference to FIG. 16, first, the user may mount the tube 2 on the tube mounting part 200 and fix the tube 2 (S111).

Thereafter, the user may pre-store the normal spray rate range of the coating liquid, which is matched with at least one of the viscosity of the coating liquid and the diameter (size) of the hollow portion of the tube 2, and the normal internal pressure range of the tube 2, which is matched with the diameter of the hollow portion of the tube 2, in the storage part (S112).

Thereafter, the viscosity detection part 400 may detect the viscosity of the coating liquid, and thereafter or at the same time, the camera 500 may be inserted into the tube 2 and then acquire the image of the inner wall of the tube 2 (S113).

Thereafter, the controller 700 may calculate the diameter of the hollow portion of the tube 2 by analyzing the image of the inner wall of the tube 2 acquired from the camera 500 (S114).

Thereafter, in order to form the coating layer with a predetermined thickness on the inner wall of the tube 2 formed with the hollow portion, the controller 700 may control the spray nozzle 340 so that the spray nozzle 340 sprays the coating liquid within the normal spray rate range of the coating liquid pre-stored in the storage part (not illustrated) and matched with at least one of the viscosity of the coating liquid detected by the viscosity detection part 400 and the diameter of the hollow portion calculated based on the image of the inner wall of the tube 2 (S115).

Thereafter, the spray nozzle 340 may be inserted into the tube 2 and then spray the coating liquid toward the inner wall of the tube 2 within the normal spray rate range pre-stored in the storage part (not illustrated) by the controller 700 (S116).

Thereafter, the controller 700 may control the pressure generation part 220 so that the internal pressure of the tube 2 detected by the pressure detection sensor (not illustrated) of the fixing part 210 is adjusted within the normal internal pressure range of the tube 2, and the pressure generation part 220 may generate the negative pressure in the tube 2 and induce the coating liquid to flow to the distal end region of the tube 2 (S117).

### Second-Third Embodiment

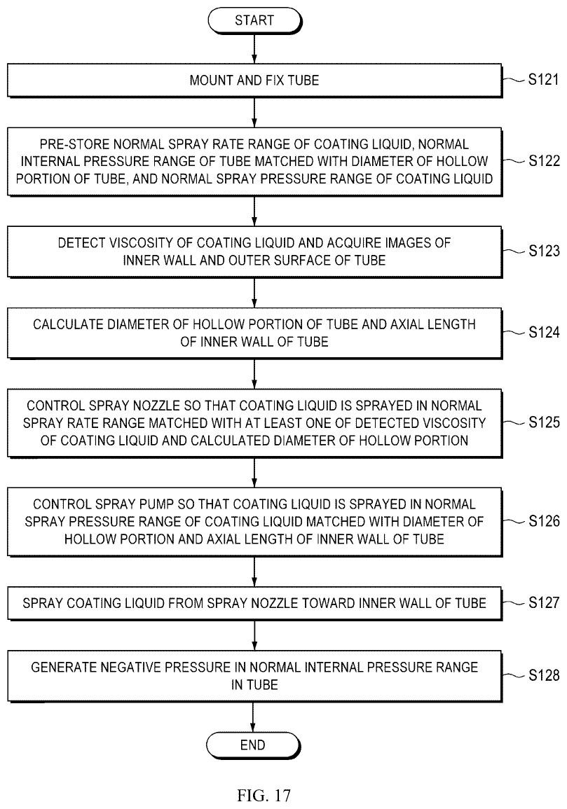

FIG. 17 is a flowchart of a tube inner wall coating method according to a second-third embodiment of the present disclosure.

With reference to FIG. 17, first, the user may mount the tube 2 on the tube mounting part 200 and fix the tube 2 (S121).

Thereafter, the user may pre-store the normal spray rate range of the coating liquid, which is matched with at least one of the viscosity of the coating liquid and the diameter (size) of the hollow portion of the tube 2, the normal internal pressure range of the tube 2 matched with the diameter of the hollow portion of the tube 2, and the normal spray pressure range of the coating liquid in the storage part (S122).

Thereafter, the viscosity detection part 400 may detect the viscosity of the coating liquid, and thereafter or at the same time, the camera 500 may be inserted into the tube 2 and then acquire the images of the inner wall and outer surface of the tube 2 (S123).

Thereafter, the controller 700 may calculate the diameter of the hollow portion of the tube 2 and the axial length of the inner wall of the tube 2 by analyzing the images of the inner wall and outer surface of the tube 2 acquired from the camera 500 (S124).

Thereafter, in order to form the coating layer with a predetermined thickness on the inner wall of the tube 2 formed with the hollow portion, the controller 700 may control the spray nozzle 340 so that the spray nozzle 340 sprays the coating liquid within the normal spray rate range of the coating liquid pre-stored in the storage part (not illustrated) and matched with at least one of the viscosity of the coating liquid detected by the viscosity detection part 400 and the diameter of the hollow portion calculated based on the image of the inner wall of the tube 2 (S125).

Thereafter, the controller 700 may control the spray pump 350 so that the spray nozzle 340 sprays the coating liquid within and the normal spray pressure range of the coating liquid pre-stored in the storage part (not illustrated) and matched with the diameter of the hollow portion of the tube 2 and the axial length of the inner wall of the tube 2 (S126).

Thereafter, the spray nozzle 340 may be inserted into the tube 2 and then spray the coating liquid toward the inner wall of the tube 2 in accordance with the normal spray rate range and the normal spray pressure range of the coating liquid that are pre-stored in the storage part (not illustrated) by the controller 700 (S127).

Thereafter, the controller 700 may control the pressure generation part 220 so that the internal pressure of the tube 2 detected by the pressure detection sensor (not illustrated) of the fixing part 210 is adjusted within the normal internal pressure range of the tube 2, and the pressure generation part 220 may induce the coating liquid to flow to the distal end region of the tube 2 (S128).

### Second-Fourth Embodiment

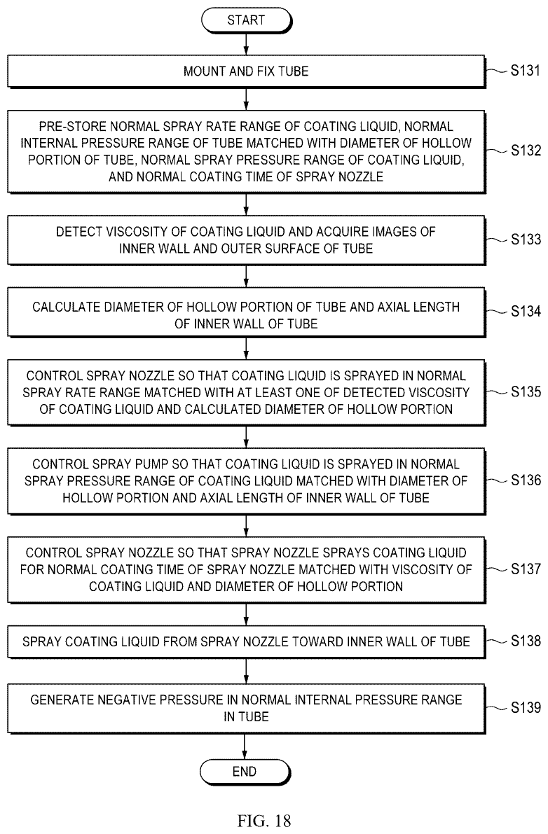

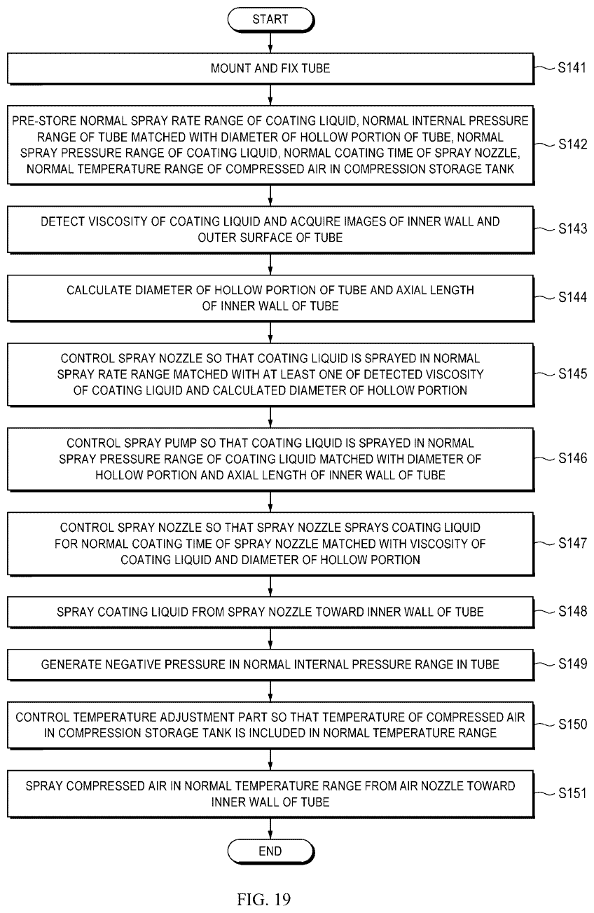

FIG. 18 is a flowchart of a tube inner wall coating method according to a second-fourth embodiment of the present disclosure.

With reference to FIG. 18, first, the user may mount the tube 2 on the tube mounting part 200 and fix the tube 2 (S131).

Thereafter, the user may pre-store the normal spray rate range of the coating liquid, which is matched with at least one of the viscosity of the coating liquid and the diameter (size) of the hollow portion of the tube 2, the normal internal pressure range of the tube 2 matched with the diameter of the hollow portion of the tube 2, the normal spray pressure range of the coating liquid, and the normal coating time of the spray nozzle 340 in the storage part (S132).

Thereafter, the viscosity detection part 400 may detect the viscosity of the coating liquid, and thereafter or at the same time, the camera 500 may be inserted into the tube 2 and then acquire the images of the inner wall and outer surface of the tube 2 (S133).

Thereafter, the controller 700 may calculate the diameter of the hollow portion of the tube 2 and the axial length of the inner wall of the tube 2 by analyzing the images of the inner wall and outer surface of the tube 2 acquired from the camera 500 (S134).

Thereafter, in order to form the coating layer with a predetermined thickness on the inner wall of the tube 2 formed with the hollow portion, the controller 700 may control the spray nozzle 340 so that the spray nozzle 340 sprays the coating liquid within the normal spray rate range of the coating liquid pre-stored in the storage part (not illustrated) and matched with at least one of the viscosity of the coating liquid detected by the viscosity detection part 400 and the diameter of the hollow portion calculated based on the image of the inner wall of the tube 2 (S135).

Thereafter, the controller 700 may control the spray pump 350 so that the spray nozzle 340 sprays the coating liquid within and the normal spray pressure range of the coating liquid pre-stored in the storage part (not illustrated) and matched with the diameter of the hollow portion of the tube 2 and the axial length of the inner wall of the tube 2 (S136).

Thereafter, the controller 700 may control the spray nozzle 340 so that the spray nozzle 340 sprays the coating liquid for the normal coating time of the spray nozzle 340 pre-stored in the storage part (not illustrated) and matched with the viscosity of the coating liquid and the diameter of the hollow portion (S137).

Thereafter, the spray nozzle 340 may be inserted into the tube 2 and then spray the coating liquid toward the inner wall of the tube 2 in accordance with the normal spray rate range, the normal spray pressure range of the coating liquid, and the normal coating time of the spray nozzle 340 that are pre-stored in the storage part (not illustrated) by the controller 700 (S138).

Thereafter, the controller 700 may control the pressure generation part 220 so that the internal pressure of the tube 2 detected by the pressure detection sensor (not illustrated) of the fixing part 210 is adjusted within the normal internal pressure range of the tube 2, and the pressure generation part 220 may induce the coating liquid to flow to the distal end region of the tube 2 (S139).

### Second-Fifth Embodiment

FIG. 19 is a flowchart of a tube inner wall coating method according to a second-fifth embodiment of the present disclosure.

With reference to FIG. 19, first, the user may mount the tube 2 on the tube mounting part 200 and fix the tube 2 (S141).

Thereafter, the user may pre-store the normal spray rate range of the coating liquid, which is matched with at least one of the viscosity of the coating liquid and the diameter (size) of the hollow portion of the tube 2, the normal internal pressure range of the tube 2 matched with the diameter of the hollow portion of the tube 2, the normal spray pressure range of the coating liquid, the normal coating time of the spray nozzle 340, and the normal temperature range of the compressed air in the compression storage tank 620 in the storage part (S142).

Thereafter, the viscosity detection part 400 may detect the viscosity of the coating liquid, and thereafter or at the same time, the camera 500 may be inserted into the tube 2 and then acquire the images of the inner wall and outer surface of the tube 2 (S143).

Thereafter, the controller 700 may calculate the diameter of the hollow portion of the tube 2 and the axial length of the inner wall of the tube 2 by analyzing the images of the inner wall and outer surface of the tube 2 acquired from the camera 500 (S144).

Thereafter, in order to form the coating layer with a predetermined thickness on the inner wall of the tube 2 formed with the hollow portion, the controller 700 may control the spray nozzle 340 so that the spray nozzle 340 sprays the coating liquid within the normal spray rate range of the coating liquid pre-stored in the storage part (not illustrated) and matched with at least one of the viscosity of the coating liquid detected by the viscosity detection part 400 and the diameter of the hollow portion calculated based on the image of the inner wall of the tube 2 (S145).

Thereafter, the controller 700 may control the spray pump 350 so that the spray nozzle 340 sprays the coating liquid within and the normal spray pressure range of the coating liquid pre-stored in the storage part (not illustrated) and matched with the diameter of the hollow portion of the tube 2 and the axial length of the inner wall of the tube 2 (S146).

Thereafter, the controller 700 may control the spray nozzle 340 so that the spray nozzle 340 sprays the coating liquid for the normal coating time of the spray nozzle 340 pre-stored in the storage part (not illustrated) and matched with the viscosity of the coating liquid and the diameter of the hollow portion (S147).

Thereafter, the spray nozzle 340 may be inserted into the tube 2 and then spray the coating liquid toward the inner wall of the tube 2 in accordance with the normal spray rate range, the normal spray pressure range of the coating liquid, and the normal coating time of the spray nozzle 340 that are pre-stored in the storage part (not illustrated) by the controller 700 (S148).

Thereafter, the controller 700 may control the pressure generation part 220 so that the internal pressure of the tube 2 detected by the pressure detection sensor (not illustrated) of the fixing part 210 is adjusted within the normal internal pressure range of the tube 2, and the pressure generation part 220 may induce the coating liquid to flow to the distal end region of the tube 2 (S149).

Thereafter, in case that the temperature detected by the temperature sensor 660 deviates from the normal temperature range after the spray nozzle 340 departs from the inside of the tube 2 to the outside when a predetermined time elapses after the coating liquid is sprayed, the controller 700 may control the temperature adjustment part 670 so that the temperature of the compressed air in the compression storage tank 620 is included in the normal temperature range pre-stored in the storage part (not illustrated) (S150).

Thereafter, the air nozzle 650 may be inserted into the tube 2 and then spray the compressed air toward the inner wall of the tube 2 in the normal temperature range pre-stored in the storage part (not illustrated) by the controller 700 (S151).

1. A tube inner wall coating apparatus comprising:
a base part having an upper plate;
a tube mounting part on which the tube is mounted so that a position of the tube formed with a hollow portion is fixed to an upper portion of the base part;
a coating liquid spray part configured to be inserted into the tube and form a coating layer on an inner wall of the tube by spraying a coating liquid toward the inner wall of the tube;
a viscosity detection part configured to detect viscosity of the coating liquid before the coating liquid spray part sprays the coating liquid;
a camera configured to acquire an image of the inner wall of the tube and an image of an outer surface of the tube;
an air spray part configured to cure the coating layer by spraying compressed air toward the inner wall of the tube formed with the coating layer; and
a controller configured to:
control the coating liquid spray part so that the coating liquid is sprayed in a normal spray rate range of the coating liquid matched with the viscosity of the coating liquid and a diameter of the hollow portion calculated by analyzing at least one of the image of the inner wall of the tube and the image of the outer surface of the tube; and
control the air spray part so that the compressed air is sprayed toward the inner wall of the tube when a predetermined time elapses after the coating liquid spray part sprays the coating liquid.

2. The tube inner wall coating apparatus of claim 1, wherein the coating liquid spray part comprises:
a spray main body;
a spray pipe slidably coupled to the spray main body and having a conduit formed in the spray pipe to provide a movement route for moving the coating liquid;
a spray valve disposed on the spray pipe and configured to open or close the movement route to allow the coating liquid to move along the spray pipe or block the movement of the coating liquid;
a spray nozzle rotatably coupled to a distal end region of the spray pipe configured to be inserted into the tube, the spray nozzle being configured to spray the coating liquid, which moves along the movement route, toward the inner wall of the tube;
a spray pump disposed on the spray pipe and configured to apply pressure to the coating liquid to move the coating liquid along the movement route;
a first sliding driving part configured to slide the distal end region of the spray pipe so that the distal end region of the spray pipe is inserted into the tube or departs from the inside of the tube to the outside; and
a nozzle rotation driving part configured to perform a rotational operation to rotate the spray nozzle about an end of the spray pipe.

3. The tube inner wall coating apparatus of claim 2, wherein the spray nozzle coats the inner wall of the tube in the form of a line by spraying the coating liquid in the form of a line along the inner wall of the tube while the spray nozzle slides in an upward/downward direction and rotates to face the inner wall of the tube based on the sliding movement of the spray pipe and the rotation made by the nozzle rotation driving part.

4. The tube inner wall coating apparatus of claim 2, wherein when the normal spray rate range of the coating liquid, which is matched with the viscosity of the coating liquid and the diameter of the hollow portion, is pre-stored in a storage part and the diameter of the hollow portion is calculated by analyzing the image of the inner wall of the tube acquired from the camera while the viscosity detection part detects the viscosity of the coating liquid, the controller controls the spray nozzle so that the spray nozzle sprays the coating liquid in the normal spray rate range of the coating liquid pre-stored in the storage part and matched with the viscosity of the coating liquid detected by the viscosity detection part and the calculated diameter of the hollow portion.

5. The tube inner wall coating apparatus of claim 4, further comprising:
a tube rotation driving part supported by the base part and configured to perform a rotational operation to rotate the tube mounting part relative to the base part.

6. The tube inner wall coating apparatus of claim 5, wherein when a normal rotational speed of the tube mounting part, which is matched with the normal spray rate range of the coating liquid, is pre-stored in the storage part, the controller controls the tube rotation driving part so that the tube mounting part rotates at the normal rotational speed pre-stored in the storage part and matched with the normal spray rate range of the coating liquid when the spray nozzle sprays the coating liquid in the normal spray rate range of the coating liquid.

7. The tube inner wall coating apparatus of claim 6, wherein when a sliding movement speed of the spray pipe and a rotational speed of the spray nozzle, which are matched with the viscosity of the coating liquid and the diameter of the hollow portion, are pre-stored in the storage part and the diameter of the hollow portion is calculated by analyzing the image of the inner wall of the tube acquired from the camera while the viscosity detection part detects the viscosity of the coating liquid, the controller controls the first sliding driving part and the nozzle rotation driving part so that the spray pipe slides and the spray nozzle rotates at the sliding movement speed of the spray pipe and the rotational speed of the spray nozzle pre-stored in the storage part and matched with the viscosity of the coating liquid detected by the viscosity detection part and the calculated diameter of the hollow portion.

8. The tube inner wall coating apparatus of claim 7, wherein when a normal angle range of the spray nozzle and a normal spray pressure range of the coating liquid, which are matched with the diameter of the hollow portion and an axial length of the inner wall of the tube, are pre-stored in the storage part and the diameter of the hollow portion and the axial length of the inner wall of the tube are calculated by analyzing the images of the inner wall and outer surface of the tube acquired from the camera, the controller controls the nozzle rotation driving part and the spray pump so that the spray nozzle sprays the coating liquid in the normal angle range of the spray nozzle and the normal spray pressure range of the coating liquid pre-stored in the storage part and matched with the diameter of the hollow portion and the axial length of the inner wall of the tube.

9. The tube inner wall coating apparatus of claim 1, wherein the air spray part comprises:
a compressor configured to produce the compressed air by compressing outside air;
a compression storage tank connected to the compressor and configured to store the compressed air discharged from the compressor;
an air pipe connected to the compression storage tank and having a conduit formed in the air pipe to provide a movement route for moving the compressed air;
an air valve disposed on the air pipe and configured to open or close the movement route to allow the compressed air to move along the air pipe or block the movement of the compressed air;
a second sliding driving part configured to slide a distal end region of the air pipe so that the distal end region of the air pipe is inserted into the tube or departs from the inside of the tube to the outside;
an air nozzle rotatably coupled to the distal end region of the air pipe configured to be inserted into the tube and configured to spray the compressed air, which moves along the movement route, toward the inner wall of the tube;
a temperature sensor disposed in the compression storage tank and configured to detect a temperature of the compressed air stored in the compression storage tank;
a temperature adjustment part disposed in the compression storage tank and configured to adjust the temperature of the compressed air stored in the compression storage tank; and
an air nozzle rotation driving part configured to perform a rotational operation to rotate the air nozzle about an end of the air pipe.

10. The tube inner wall coating apparatus of claim 9, wherein the air nozzle cures the coating layer with an uniform thickness formed on the inner wall of the tube by spraying the compressed air in the form of a line along the inner wall of the tube while the air nozzle slides in an upward/downward direction and rotates to face the inner wall of the tube based on the sliding movement of the air pipe and the rotation made by the air nozzle rotation driving part.

11. The tube inner wall coating apparatus of claim 9, wherein when a normal temperature range of the compressed air in the compression storage tank and a sliding movement speed of the air pipe and a rotational speed of the air nozzle, which are matched with the normal temperature range of the compressed air, are pre-stored in a storage part and the temperature detected by the temperature sensor deviates from the normal temperature range, the controller controls the temperature adjustment part so that the temperature of the compressed air in the compression storage tank is included in the normal temperature range pre-stored in the storage part.

12. The tube inner wall coating apparatus of claim 11, wherein the controller controls the second sliding driving part and the air nozzle rotation driving part so that the air pipe slides and the air nozzle rotates at the rotational speed at the sliding movement speed of the air pipe and the rotational speed of the air nozzle pre-stored in the storage part and matched with the temperature of the compressed air in the normal temperature range detected by the temperature sensor.

13. A tube inner wall coating apparatus comprising:
a base part having an upper plate;
a pressure adjustment part comprising a fixing part configured to fix a position of a tube formed with a hollow portion to an upper portion of the base part, and a pressure generation part configured to apply pressure into the tube while a coating liquid is sprayed toward an inner wall of the tube;
a coating liquid spray part configured to be inserted into the tube and form a coating layer on the inner wall of the tube by means of a spray nozzle configured to spray the coating liquid;
a viscosity detection part configured to detect viscosity of the coating liquid before the coating liquid spray part sprays the coating liquid;
a camera configured to acquire an image of the inner wall of the tube and an image of an outer surface of the tube;
an air spray part configured to cure the coating layer by spraying compressed air toward the inner wall of the tube formed with the coating layer; and
a controller configured to:
control the coating liquid spray part so that the coating liquid is sprayed in a normal spray rate range of the coating liquid matched with the viscosity of the coating liquid and a diameter of the hollow portion calculated by analyzing at least one of the image of the inner wall of the tube and the image of the outer surface of the tube; and
control the air spray part so that the compressed air is sprayed toward the inner wall of the tube when a predetermined time elapses after the coating liquid spray part sprays the coating liquid.

14. The tube inner wall coating apparatus of claim 13, wherein the pressure generation part is provided at an upper end of the fixing part configured to come into contact with a distal end region of the tube held by the fixing part, and
wherein the pressure generation part applies pressure to the hollow portion of the tube from the distal end region of the tube and induces the coating liquid, which is sprayed onto the inner wall of the tube, to flow toward the distal end region of the tube when the distal end region of the tube is held by the fixing part and the position of the tube is fixed.

15. The tube inner wall coating apparatus of claim 14, wherein the hollow portion of the tube is sealed by the spray nozzle and an upper end of the fixing part, and
wherein the pressure generation part generates negative pressure in the tube by generating a pressure difference between an upper end of the tube including one side of the hollow portion of the tube, into which the spray nozzle is inserted, and a lower end of the tube including the distal end region of the tube when the hollow portion of the tube is sealed, and the pressure generation part induces the coating liquid, which is sprayed onto the inner wall of the tube, to flow to the distal end region of the tube in accordance with the pressure difference between the upper end of the tube and the lower end of the tube.

16. The tube inner wall coating apparatus of claim 13, wherein the coating liquid spray part comprises:
a spray main body;
a spray pipe slidably coupled to the spray main body and having a conduit formed in the spray pipe to provide a movement route for moving the coating liquid;
a spray valve disposed on the spray pipe and configured to open or close the movement route to allow the coating liquid to move along the spray pipe or block the movement of the coating liquid;
the spray nozzle coupled to a distal end region of the spray pipe configured to be inserted into the tube, the spray nozzle being configured to spray the coating liquid, which moves along the movement route, toward the inner wall of the tube;
a spray pump disposed on the spray pipe and configured to apply pressure to the coating liquid to allow the coating liquid to move along the movement route; and
a first sliding driving part configured to slide the distal end region of the spray pipe so that the distal end region of the spray pipe is inserted into the tube or departs from the inside of the tube to the outside.

17. The tube inner wall coating apparatus of claim 16, wherein when the normal spray rate range of the coating liquid, which is matched with at least one of the viscosity of the coating liquid and the diameter of the hollow portion, is pre-stored in a storage part and the diameter of the hollow portion is calculated by analyzing the image of the inner wall of the tube acquired from the camera while the viscosity detection part detects the viscosity of the coating liquid, the controller controls the spray nozzle so that the spray nozzle sprays the coating liquid in the normal spray rate range of the coating liquid pre-stored in the storage part and matched with at least one of the viscosity of the coating liquid detected by the viscosity detection part and the calculated diameter of the hollow portion.

18. The tube inner wall coating apparatus of claim 17, wherein the fixing part is provided at an upper end of a pressure detection sensor configured to detect internal pressure of the tube, and
wherein when a normal internal pressure range of the tube, which is matched with the diameter of the hollow portion of the tube, is pre-stored in the storage part and the pressure detection sensor detects the internal pressure of the tube, the controller controls the pressure generation part so that the internal pressure of the tube detected by the pressure detection sensor is adjusted in the normal internal pressure range of the tube.

19. The tube inner wall coating apparatus of claim 18, wherein when a normal spray pressure range of the coating liquid, which is matched with the diameter of the hollow portion and an axial length of the inner wall of the tube, is pre-stored in the storage part and the diameter of the hollow portion and the axial length of the inner wall of the tube are calculated by analyzing the images of the inner wall and outer surface of the tube acquired from the camera, the controller controls the spray pump so that the spray nozzle sprays the coating liquid in the normal spray pressure range of the coating liquid pre-stored in the storage part and matched with the diameter of the hollow portion and the axial length of the inner wall of the tube.

20. The tube inner wall coating apparatus of claim 19, wherein when a normal coating time of the spray nozzle, which is matched with the viscosity of the coating liquid and the diameter of the hollow portion, is pre-stored in the storage part and the diameter of the hollow portion is calculated by analyzing the image of the inner wall of the tube acquired from the camera while the viscosity detection part detects the viscosity of the coating liquid, the controller controls the spray nozzle so that the spray nozzle sprays the coating liquid for the normal coating time pre-stored in the storage part and matched with the viscosity of the coating liquid detected by the viscosity detection part and the calculated diameter of the hollow portion.

21. The tube inner wall coating apparatus of claim 13, wherein the air spray part comprises:
a compressor configured to produce the compressed air by compressing outside air;
a compression storage tank connected to the compressor and configured to store the compressed air discharged from the compressor;
an air pipe connected to the compression storage tank and having a conduit formed in the air pipe to provide a movement route for moving the compressed air;
an air valve disposed on the air pipe and configured to open or close the movement route to allow the compressed air to move along the air pipe or block the movement of the compressed air;
a second sliding driving part configured to slide a distal end region of the air pipe so that the distal end region of the air pipe is inserted into the tube or departs from the inside of the tube to the outside;
an air nozzle coupled to the distal end region of the air pipe configured to be inserted into the tube and configured to spray the compressed air, which moves along the movement route, toward the inner wall of the tube;
a temperature sensor disposed in the compression storage tank and configured to detect a temperature of the compressed air stored in the compression storage tank; and
a temperature adjustment part disposed in the compression storage tank and configured to adjust the temperature of the compressed air stored in the compression storage tank.

22. The tube inner wall coating apparatus of claim 21, wherein when a normal temperature range of the compressed air in the compression storage tank is pre-stored in a storage part and the temperature detected by the temperature sensor deviates from the normal temperature range, the controller controls the temperature adjustment part so that the temperature of the compressed air in the compression storage tank is included in the normal temperature range pre-stored in the storage part.
